(19) United States
(12) Patent Application Publication
(10) Pub. No.: US 2002/0013940 A1
(43) Pub. Date: Jan. 31, 2002

(54) Content rental system

(76) Inventors: Yuji Tsukamoto, Tokyo (JP); Takahiko Tsujisawa, Tokyo (JP); Jun Ishikawa, Tokyo (JP); Yasushi Kikkawa, Tokyo (JP); Katsuaki Yamamoto, Tokyo (JP); Satoshi Yamakawa, Tokyo (JP); Kantarou Oota, Tokyo (JP); Naoki Soeda, Tokyo (JP); Yoshihide Kikuchi, Tokyo (JP); Koichi Funaya, Tokyo (JP); Osamu Otsuka, Tokyo (JP)

Correspondence Address: David A. Blumenthal, FOLEY & LARDNER, Washington Harbour, 3000 K Street, N.W., Suite 500, Washington, DC, 20007-5109, US

(21) Appl. No.: 09/851,424

(22) Filed: May 9, 2001

(30) Foreign Application Priority Data
May 11, 2000 (JP) 2000-139115
Jan. 22, 2001 (JP) 2001-013815

(51) Int. Cl. H04N 7/16

(52) U.S. Cl. 725/5

(57) ABSTRACT

A content rental system is disclosed, that comprises a content producer for producing a content, a rental business server, disposed in a store managed by a rental business operator, for recording the content produced by the content producer and downloading the content to a record medium corresponding to a command issued by a customer, and a reproducing device, disposed in the house of the customer, for reproducing the content from the record medium.

### BACKGROUND OF THE INVENTION

1. Field of the Invention

The present invention relates to a content rental system for renting contents such as movies, post-broadcast television programs, and educational video programs.

2. Description of the Prior Art

FIG. 1 shows an outlined structure of a conventional rental system for video software titles. Referring to FIG. 1, a video source production company 1 and a video software title production company 6 make a video software title distribution right practicing commission contract 15. The video source production company 1 distributes a video software title production master tape as a master tape supply 17 to the video software title production company 6. The video software title production company 6 produces a plurality of rental video software title copies using the distributed video software title master tape. The video software title production company 6 pays a royalty 16 for the master tape supply 17 to the video source production company 1. The rental video software title copies are mainly magnetic tapes. The rental video software titles copies may be read-only optical discs such as laser discs and DVD-ROMs.

As an intermediate distributor disposed between the video software title production company 6 and a rental business operator 3, there is a wholesaler 7. The video software title production company 6 supplies rental stock 61 such as rental video software title copies as rental stock 71 to the rental business operator 3 through the wholesaler 7. The wholesaler 7 pays a royalty 62 for the rental stock 71 to the video software title production company 6. In addition, the rental business operator 3 pays the fee of the video software title copies to the wholesaler 7. At that point, the rental business operator 3 reports the number of sold copies of the video software title to the wholesaler 7. There may be a direct sales contract in which there is no wholesaler 7 as an intermediate distributor.

In addition, the video software title production company 6 and various copyright associations 5 make a royalty collection commission contract 51 for collecting copyright royalty of video software titles. The video software title production company 6 pays a copyright royalty 52 to the various copyright associations 5.

About a licensing contract such as copyright, as shown in FIG. 2, there is a distribution right commission association (for example, Japan Video Soft Association, which is a special corporation) 8. The distribution right commission association 8 and the video software title production company 6 makes a distribution right practicing commission contract 64. In addition, the rental business operator 3 submits a rental licensing application 81 to the distribution right commission association 8. When the distribution right commission association 8 grants the rental licensing application 81 to the rental business operator 3, the distribution right commission association 8 provides a member store plate 83 to the rental business operator 3. In addition, the distribution right commission association 8 and the rental business operator 3 makes a rental business licensing contract 84. Likewise, the rental business operator 3 and the various copyright associations 5 make a rental business licensing contract 84. Copyright royalty is paid as a system member fee 82. The copyright royalty may be paid to the various copyright associations 5 through the distribution right commission association 8.

The above-described conventional video software title rental system has the situations and problems as follows:

(1) When the rental business operator 3 purchases video software title copies, he or she should accurately predict the number of copies per video software title that will be rented at the same time and the turnover rate thereof in consideration of the demand. If the rental business operator 3 buys more copies than demanded copies because of an inaccurate prediction, he or she will have improper stock. In contrast, when more copies are demanded than predicted copies, the rental business operator 3 will lose a business chance because he or she does not have sufficient stock.

(2) Like the rental business operator 3, the video software title production company 6 has the same problem. The video software title production company 6 should consider how many rental magnetic tapes he or she will produce from the master tape. For example, copies of a video software title whose turnover rate is low are circulated at low prices to the second hand market, the prices of sell copies of the video software title are lowered.

(3) Copies of conventional video software titles with magnetic tapes often contain previews of movies that will be produced by the video source production company and commercials of video software titles that will be newly sold. Although the commercials (namely, advertisements) contribute to reduce the prices of copies of video software titles, when the copies of the video software titles become old, the commercial effects will become low. In addition, the audiences will be confused by the commercials.

(4) As a problem that does not relate to the distribution system, the quality of a magnetic tape of a copy of a video software title deteriorates as the number of rental times increases. This adversely affects the customers of the rental services. The customers may not clearly view programs of rental video software title copies with noise due to a tracking error or the like.

(5) So far, there is a problem about illegal copies of video software titles. When video software titles are digitized, illegal copies thereof will become a critical problem that adversely affect the managements of the video source production company 1 and the video software title production company 6.

### SUMMARY OF THE INVENTION

The present invention is made in consideration of the above-described situations. An object of the present invention is to provide a content rental system that prevents a rental business operator from having improper stock and loosing a business chance, preventing the prices of sell copies of video software titles from lowering, allows the latest commercials to be inserted into rental copies of video software titles, and prevents illegal copies from being produced.

The present invention is a content rental system, comprising a content producer for producing a content, a rental business server, disposed in a store managed by a rental business operator, for recording a content produced by the content producer and downloading the content to a record medium corresponding to a command issued by a customer, and a reproducing device, disposed in the house of the customer, for reproducing the content from the record medium.

The rental business operator records an advertisement picture to the record medium along with the content.

When an icon contained in the advertisement picture is clicked, the reproducing device is connected to an advertisement server through the Internet.

The record medium comprises a content storing portion for storing the content encrypted, a memory for storing a decryption key for decrypting the content, and a capacitor for backing up the memory, wherein the capacitor is charged by the rental business server.

The record medium comprises a content storing portion for storing the content, a memory for storing a control algorithm for reading the content, and a capacitor for backing up the memory, wherein the capacitor is charged by the rental business server.

The record medium comprises a content storing portion for storing the content encrypted, a memory for storing a decryption key for decrypting the content, and a timer for causing data stored in the memory to be erased when a predetermined time period elapses after the record medium is connected to the rental business server.

The record medium comprises a content storing portion for storing the content, a memory for storing a control algorithm for reading the content, and a timer for causing data stored in the memory to be erased when a predetermined time period elapses after the record medium is connected to the rental business server.

The content rental system further comprises capacitor, charged by the rental business server, for supplying a power to the timer.

The present invention is a content rental system for downloading a content to a record medium of a customer and managing the security of the content corresponding to data stored in an IC card of the customer, comprising a content producer for producing the content, a management center for delivering the content produced by the content producer to a plurality of rental business operators, a rental business server, disposed in a store managed by each of the rental business operators, for recording the content delivered from the management center, downloading the recorded content to the record medium corresponding to a command issued by the customer, and managing the security of the content corresponding to the data stored in the IC card, and a reproducing device, disposed in the house of the customer, for restoring the content from the record medium and managing the security of the content corresponding to the data stored in the IC card.

When the IC card is set to the reproducing device, the reproducing device authenticates the IC card and the IC card authenticates the reproducing device.

The reproducing device is authenticated by a process in which the reproducing device transmits a reproducing device public key certificate to the IC card and the IC card authenticates the reproducing device public key certificate. The IC card is authenticated by a process in which the IC card transmits an IC card public key certificate to the reproducing device and the reproducing device authenticates the IC card public key certificate.

The reproducing device is authenticated in such a manner that the IC card encrypts a random number using a reproducing device public key and transmits the encrypted random number to the reproducing device, that the reproducing device decrypts the encrypted random number using a reproducing device secret key and transmits the decrypted random number to the IC card, and that the IC card authenticates the reproducing device using the decrypted random number.

The IC card is authenticated in such a manner that the reproducing device encrypts a random number using an IC card public key and transmits the encrypted random number to the IC card, that the IC card decrypts the encrypted random number using an IC card secret key and transmits the decrypted random number to the reproducing device, and that the reproducing device authenticates the IC card using the decrypted random number.

When the IC card is set to the rental business server, the rental business server authenticates the IC card in cooperation with the management center.

The IC card is authenticated by a process in which the IC card transmits an IC card public key certificate to the management center through the rental business server and the management center authenticates the IC card public key certificate.

The IC card is authenticated in such a manner that the management center encrypts a random number using an IC card public key and transmits the encrypted random number to the IC card through the rental business server, that the IC card decrypts the encrypted random number using an IC card secret key and transmits the decrypted random number to the management center through the rental business server, and that the management center authenticates the IC card using the decrypted random number.

When the IC card is set to the rental business server, the IC card transmits a reproducing device public key certificate to the management center through the rental business server and the management center authenticates the reproducing device corresponding to the reproducing device public key certificate.

When the record medium and the IC card are set to the rental business server and the customer selects a content, the rental business server transmits contract information to the IC card. The IC card encrypts the contract information and transmits the encrypted contract information to the management center through the rental business server. After the management center decrypts the encrypted contract information and authenticates the contract information, the management center encrypts an encryption key of the content selected by the customer and transmits the encrypted content to the IC card through the rental business server. After the IC card decrypts the encrypted content encryption key and authenticates the content, the IC card transmits a normal completion message to the rental business server. The rental business server receives the normal completion message and downloads the content to the record medium.

When the record medium and the IC card are set to the reproducing device, the reproducing device transmits a content encryption key transmission request to the IC card. The IC card receives the transmission request, encrypts a content encryption key, and transmits the encrypted content encryption key to the reproducing device. After the reproducing device decrypts the encrypted content encryption key and authenticates the decrypted content encryption key, the reproducing device reproduces the content using the decrypted content encryption key.

These and other objects, features and advantages of the present invention will become more apparent in light of the following detailed description of a best mode embodiment thereof, as illustrated in the accompanying drawings.

### BRIEF DESCRIPTION OF DRAWINGS

FIG. 1 is a block diagram showing the structure of a conventional video tape rental system;

FIG. 2 is a block diagram showing the structure of the conventional video tape rental system;

FIG. 3 is a block diagram showing the structure of an embodiment of the present invention;

FIG. 4 is a block diagram showing a modification of the embodiment;

FIG. 5 is a block diagram showing an example of the structure of an RHDD (removable magnetic disk device) according to the embodiment shown in FIG. 3 or 4;

FIG. 6 is a flow chart for explaining the operation of the RHDD shown in FIG. 5;

FIG. 7 is a block diagram showing the state that the RHDD shown in FIG. 5 is connected to a reproducing device;

FIG. 8 is a block diagram for explaining a reproducing operation of the RHDD shown in FIG. 7;

FIG. 9 is a block diagram showing an example of another structure of the RHDD;

FIG. 10 is a block diagram for explaining the operation of the RHDD shown in FIG. 9;

FIG. 11 is a block diagram showing an example of another structure of the RHDD;

FIG. 12 is a block diagram showing an example of another structure of the RHDD;

FIG. 13 is a block diagram showing an example of another structure of the RHDD;

FIG. 14 is a block diagram for explaining the operation of the RHDD shown in FIG. 13;

FIG. 15 is a block diagram for explaining the operation of the RHDD shown in FIG. 13;

FIG. 16 is a block diagram showing an example of another structure of the RHDD;

FIG. 17 is a block diagram showing an example of a structure in which the reproducing device shown in FIG. 16 is substituted with a reproducing device having another structure;

FIG. 18 is a block diagram showing the structure of another embodiment of the present invention;

FIG. 19 is a block diagram showing the structure of a management center 160 according to the embodiment shown in FIG. 18;

FIG. 20 is a block diagram showing the structure of a server 162 according to the embodiment shown in FIG. 18;

FIG. 21 is a block diagram showing the structure of an IC card 167 according to the embodiment shown in FIG. 18;

FIG. 22 is a block diagram showing the structure of a reproducing device 170 according to the embodiment shown in FIG. 18;

FIG. 23 is a flow chart showing a mutual authenticating operation of the reproducing device 170 and the IC card 167 according to the embodiment shown in FIG. 18;

FIG. 24 is a flow chart showing a mutual authenticating operation of the management center 160 and the IC card 167 according to the embodiment shown in FIG. 18;

FIG. 25 is a flow chart showing a transferring process for a reproducing device public key certificate from the IC card 167 to the management center 160 according to the embodiment shown in FIG. 18;

FIG. 26 is a flow chart showing a content downloading process according to the embodiment shown in FIG. 18;

FIG. 27 is a flow chart showing a content reproducing process according to the embodiment shown in FIG. 18;

FIG. 28 is a block diagram showing the overall structure of another embodiment of the present invention;

FIG. 29 is a block diagram showing the structure of a store server 701 shown in FIG. 28;

FIG. 30 is a block diagram showing the structure of an RHDD 704 shown in FIG. 28; and

FIG. 31 is a block diagram showing the structure of a reproducing device 705 shown in FIG. 28.

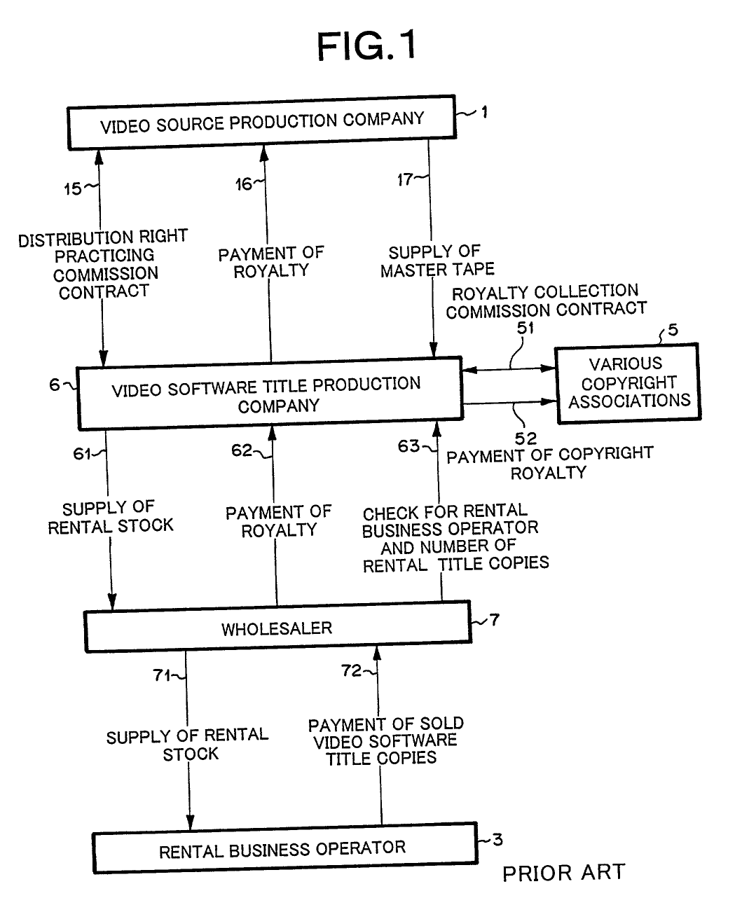

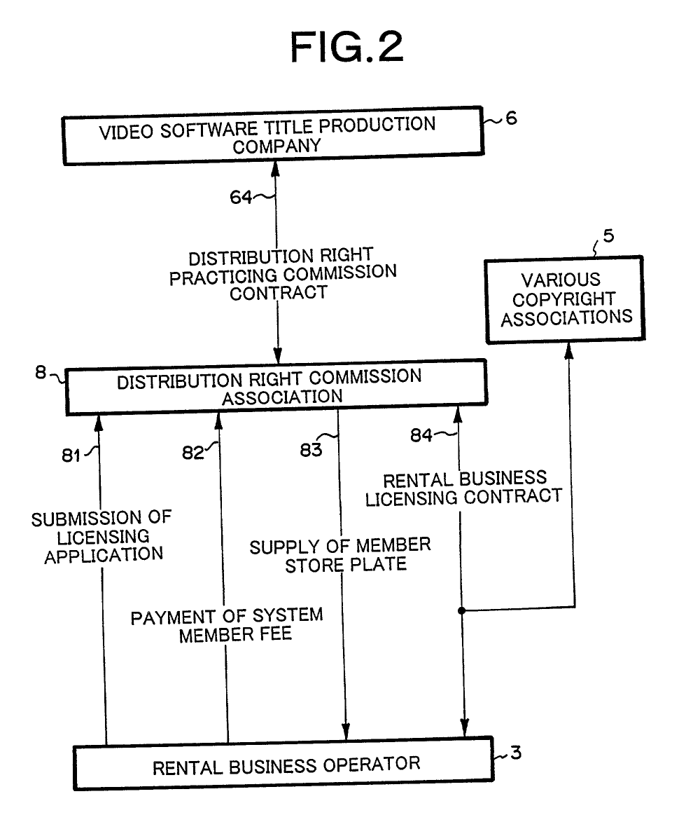

### DESCRIPTION OF PREFERRED EMBODIMENTS

<First Embodiment>

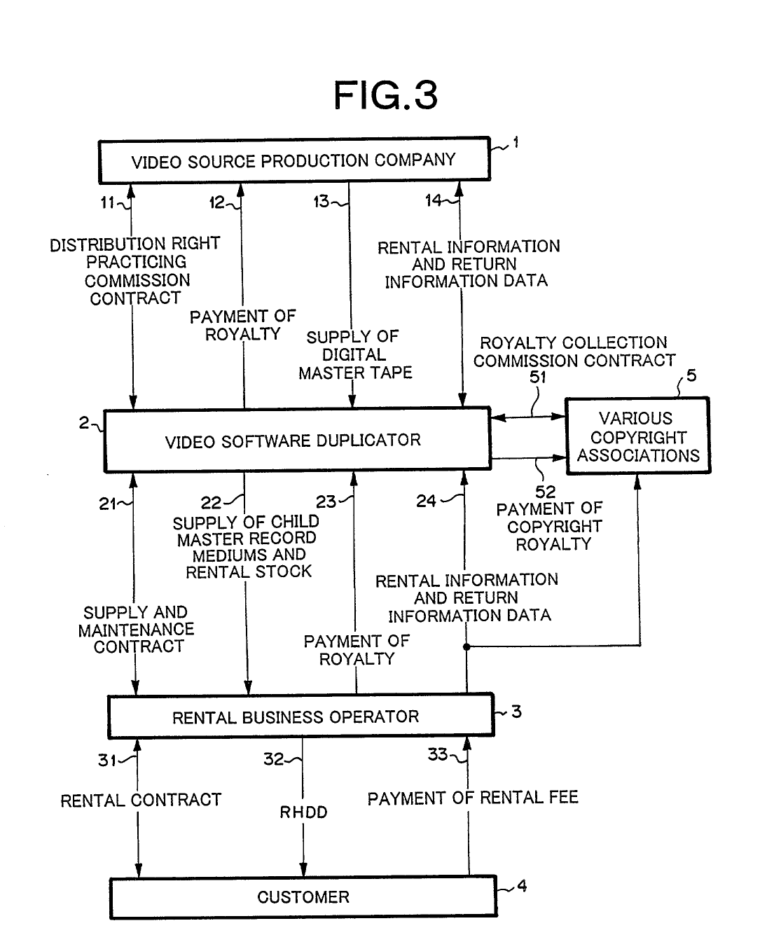

FIG. 3 is a block diagram showing the overall structure of a content rental system according to a first embodiment of the present invention. In FIG. 3, a video source production company 1 produces a video master. The video source production company 1 has a photographing camera, a digital picture converting—processing device, a computer, and so forth as hardware. The photographing camera photographs a picture corresponding to a scenario. The digital picture converting—processing device converts a photographed picture of a film into a digital picture. The computer manages and controls those devices.

A video software duplicator 2 has a duplicating device that duplicate the video master supplied from the video source production company 1 and produces child master record mediums thereof In addition, the video software duplicator 2 manages information such as the title name of the video master, the actor names of the video software title, and the performance duration thereof. Moreover, the video software duplicator 2 deals with management information and operational information such as the number of produced child master record mediums.

Various copyright associations 5 collect copyright royalty for video masters, music programs, arts, and so forth. In addition, the various copyright associations 5 deal with copyright infringements and allot collected money to copyright owners using server terminal units.

A rental business operator 3 has a server terminal unit which has interface units in order to duplicate the video software to a portable record medium, i.e., RHDD, using a child master record medium delivered from the video software duplicator 2. When a customer wants to rent a content, the rental business operator 3 duplicates the content to RHDD using the server terminal unit and rents the RHDD to the customer. In addition, the rental business operator 3 has a service server terminal unit that calculates the rental period between the rental start date and the rental end date of the RHDD rented to the customer and the rental fee thereof and collects the rental fee from the customer. In addition, the rental business operator 3 has a network terminal unit that exchanges information with other cooperative rental business operators 3, the various copyright associations 5, and the video software duplicator 2.

A customer 4 rents a rental RHDD from the rental business operator 3 for several hours or several days.

Next, the operation of the above-described system will be described.

The video source production company 1 produces video masters and supplies them to movie theaters, music concerts, and so forth. In addition, the video source production company 1 prepares rental video masters. The video source production company 1 and the video software duplicator 2 make a video software title distribution right practicing commission contract 11. The video software duplicator 2 receives a digital master tape that can be directly recorded to a magnetic disk device from the video source production company 1 and pays the royalty 12 thereof to the video source production company 1. To share rental information and return information data 14, the video software duplicator 2 exchanges the title name of the video master, the number of produced child master record mediums, and return date with the video source production company 1.

The video software duplicator 2 and the various copyright associations 5 make a royalty collection commission contract 51 as information notification duties for the title names of magnetic mediums of the video master and child masters, and the number of replicated copies. The video software duplicator 2 pays a copyright royalty 52 for child master record mediums to the various copyright associations 5.

In addition, the video software duplicator 2 and the rental business operator 3 make a supply and maintenance contract 21 for child master record mediums and so forth. The video software duplicator 2 distributes a child master magnetic disc medium for video information recorded corresponding to the digital master tape and rental stock 22 to the rental business operator 3 using a physical distributing means such as a courier service. The rental business operator 3 pays a royalty 23 for the child master record medium to the video software duplicator 2 and notifies the video software duplicator 2 of the rental information and return information data 24.

Alternatively, video information of a digital master tape may be delivered to a plurality of rental business operators 3 through a satellite broadcast or the Internet. In this case, the rental business operators 3 may directly produce child master magnetic disk devices.

The rental business operator 3 and the customer 4 make a rental contract 31 for a rental fee, a rental period, and so forth. The rental business operator 3 rents an RHDD 32 to the customer 4. The customer 4 pays the rental fee to the rental business operator 3 in cash or by a credit card.

The video software duplicator 2 produces a child master magnetic disk device that contains a commercial picture that is inserted at the beginning or the end thereof for a sponsor who made an advertisement contract therewith in agreement with the video source production company 1. Alternatively, the video software duplicator 2 produces a child master magnetic disk device for only a commercial picture. Like the video software title information, the commercial information may be delivered to a plurality of rental business operators 3 through a satellite broadcast or the Internet. Each rental business operators 3 may produce a child master magnetic disk device that contains the commercial information.

When a customer knows that the rental business operator 3 has prepared a rental title that the customer wants to rent, he or she can rent an RHDD for the video software title and commercial information. At that point, the rental business operator 3 duplicates the video software title to RHDD using the child master magnetic disk device and the child master magnetic disk device for the commercial information. The downloading process for the RHDD is performed by a dedicated server terminal unit disposed in the rental business operator 3.

When the rental business operator 3 rents the RHDD to the customer 4, the rental business operator 3 collects the rental fee from the customer 4 corresponding to the rental contract. When the rental business operator 3 rents the RHDD to the customer 4, a label maker device integrated with the dedicated server terminal unit creates a rental and customer management label that indicates the title name recorded in the RHDD, the rental period, the customer name who rents the RHDD, and the customer management attribute data. The rental business operator 3 rents the RHDD with the label to the customer 4. At that point, a POS (Point of Sales) terminal unit having a label reader is used to read the video software title name, the rental period, the customer name, and the customer management attribute data. Those data that is read by the POS terminal unit is shared by the various copyright associations 5, the video source production company 1, the video software duplicator 2, and the rental business operator 3 so as to check the basis of the royalty charged thereamong.

When the customer 4 returns the RHDD to the rental business operator 3, it reads the rental and customer management label and confirms the return of the RHDD. The server terminal units of the various copyright associations 5, the video source production company 1, the video software duplicator 2, and the rental business operator 3 are connected through the Internet. The title name produced from the video master by the video software duplicator 2, the number of child master magnetic disk mediums produced from the video digital master tape, the names of the rental business operators 3 to which the child master magnetic tape disk mediums were distributed, the title names of the video software titles produced from the child master magnetic disk mediums by the rental business operator 3, the number of rented RHDDs, the rental periods thereof, the attributes of the rented customers 4, and information about returns of the rented RHDDs from the customers 4 to the rental business operators 3 are shared by the various copyright associations 5, the video source production company 1, the video software duplicator 2, and the rental business operators 3. Predetermined fees for copyright royalty and transactions are charged and collected corresponding to the shared data based on the contracts made among the various copyright associations 5, the video source production company 1, the video software duplicator 2, and the rental business operators 3.

To accurately and effectively perform the above-described transactions, the server terminal units that deal with various management data information of the transactions and perform the downloading process should be integrally maintained and managed between the video software duplicator 2 and each rental business operator 3. Thus, the video software duplicator 2 and each rental business operator 3 make a business commission contract for maintenance and management of the downloading server terminal unit of the rental business operator 3, the label maker that creates rental labels in cooperation with the downloading server terminal unit, the driving device for child master magnetic disk mediums, and the rental RHDD record mediums. Fees for delivery, maintenance, and management of devices and record mediums corresponding to the commission contract are collected corresponding to information exchanged between each rental business operator 3 and the video software duplicator 2 through the Internet.

To prevent digital video information from being illegally copied and circulated, each child master record medium and each RHDD may have respective clock functions. In addition, an RHDD driving device may have a function for automatically erasing video information from the record medium when a predetermined time period elapses after the date of the contract made between the video software duplicator 2 and each rental business operator 3 or the contract between each rental business operator 3 and each customer 4 or when the number of times of the downloading operation exceeds a predetermined value.

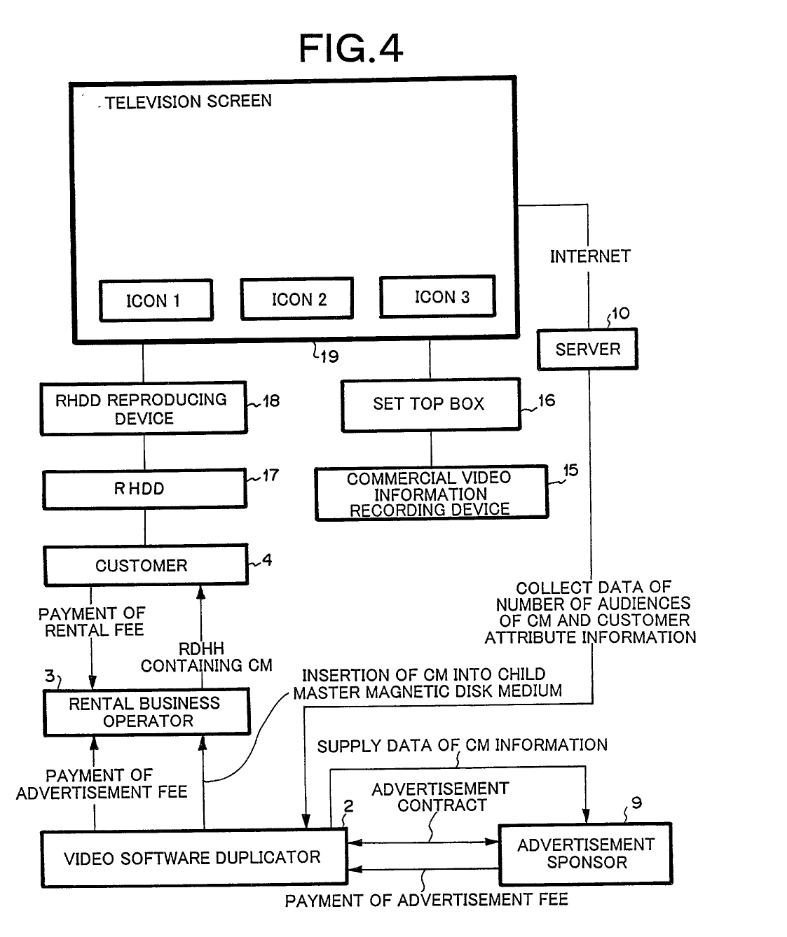

Next, with reference to FIG. 4, a modification of the first embodiment will be described. In the modification, the video software duplicator 2 and an advertisement sponsor 9 make an advertisement contract. The video software duplicator 2 receives a commercial digital master tape from the advertisement sponsor 9 who has the copyright thereof. For the distribution of the commercial digital master tape, the advertisement sponsor 9 pays the advertisement fee to the video software duplicator 2. The video software duplicator 2 produces a child master magnetic disk medium for the commercial information at the beginning or the end thereof. Alternatively, the video software duplicator 2 produces a child master magnetic disk medium for only commercial information. The video software duplicator 2 distributes the produced child master magnetic disk mediums to the rental business operators 3. Alternatively, like a video software title, commercial information is delivered to the rental business operators 3 through a satellite broadcast or the Internet. Each rental business operator 3 produces the copy of the video software title and the commercial information on the RHDD using a delivered child master magnetic disk medium and rends the produced RHDD to a customer 4.

The video software duplicator 2 collects rental information of RHDDs that contain the commercial information of the advertisement sponsor 9 from each rental business operator 3 through a communication network such as the Internet and charges the advertisement sponsor 9 for the advertisement fee of the commercial information. In addition, the video software duplicator 2 pays part of the commercial fee to each rental business operator 3 corresponding to the contact made therebetween. A commercial picture may contain icons jumped to information screens such as the home page of the advertisement sponsor 9, a gift, and a lottery from which each customer 4 may have a benefit. When the customer 4 clicks an icon in the commercial picture, a relevant information screen appears through the Internet.

After the customer 4 sets the rented RHDD 17 to an RHDD reproducing device 18, icons 1, 2, and 3 appear on a television screen 19. When the customer 4 clicks one of these icons 1, 2, and 3 using an operation board such as a keyboard or a mouse, he or she can select desired information. When an icon is selected, the television is connected to a commercial server 10 through the Internet. As a result, a web page of the commercial server 10 appears on the television. The web page displays an advertisement, a gift, a lottery, or the like corresponding to the selected icon.

The video software duplicator 2 receives data such as the number of audiences of the commercial and customer attribute information corresponding to the selected icon from the commercial server 10 through the Internet. The video software duplicator 2 provides the attribute information of the customers 4 and the number of audiences of the commercial to the advertisement sponsor 9 and collects the commercial fee from the advertisement sponsor 9. The video software duplicator 2 shares the collected fee with each rental business operator 3 corresponding to the contract made therebetween.

Since the advertisement sponsor 9 pays the advertisement fee corresponding to the advertisement results, the advertisement efficiency of the advertisement sponsor 9 becomes high. Thus, the advertisement achievement ratio becomes clearer than the method in which the advertisement fee is paid corresponding to the prediction although the relation between the advertisement results and the sales results is not considered.

According to the first embodiment, video software titles are rented. However, audio (music) information can be rented. Alternatively, information of dictionaries, art information, or a variety of multimedia such as computer programs as software can be rented.

<Second Embodiment>

Next, an RHDD 17, a downloading server (managed by each rental business operator 3), and a reproducing device (of each customer) according to the first embodiment will be described.

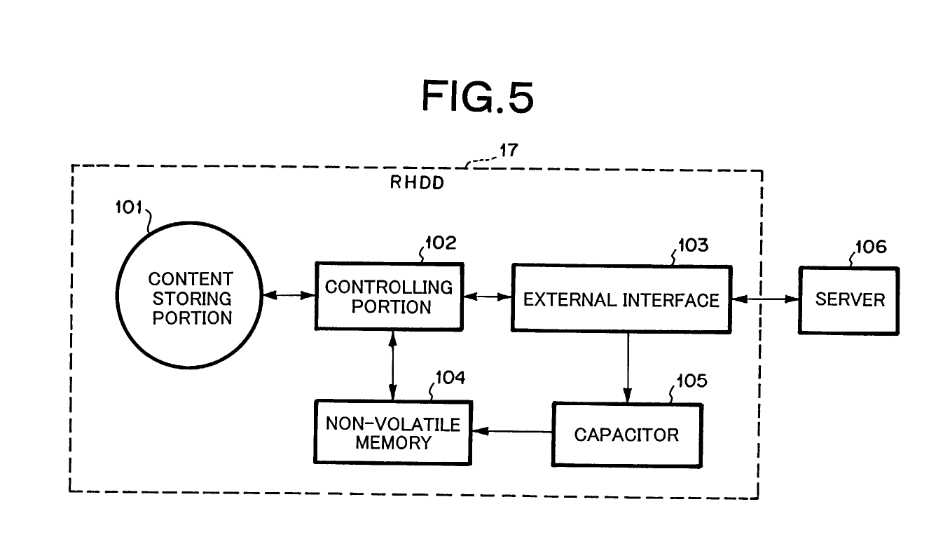

FIG. 5 is a block diagram showing the structure of the RHDD 17. In FIG. 5, a content storing portion 101 stores contents received from a downloading server 106 managed by each rental business operator 3. The contents that are stored in the content storing portion 101 are read and written under the control of a controlling portion 102. The RHDD 17 is composed of a magnetic disk, a non-volatile memory, or the like.

The controlling portion 102 receives a power from the server 106 and controls the reading and writing operations of the content storing portion 101 and a non-volatile memory 104. The controlling portion 102 has a function for determining whether or not a device connected to the RHDD 17 is valid. An external interface 103 is an interface that connects the RHDD 17 to the server 106 or the reproducing device. The external interface 103 receives a power from the server 106 or the reproducing device and inputs and outputs contents and information necessary for reproducing the contents from or to an external device. When the external interface 103 is connected to the downloading server 106, a capacitor 105 is charged with a power supplied from the server 106. The non-volatile memory 104 is backed up by the capacitor 105. The reading and writing operations of the non-volatile memory 104 are controlled by the controlling portion 102. The non-volatile memory 104 stores a decryption key.

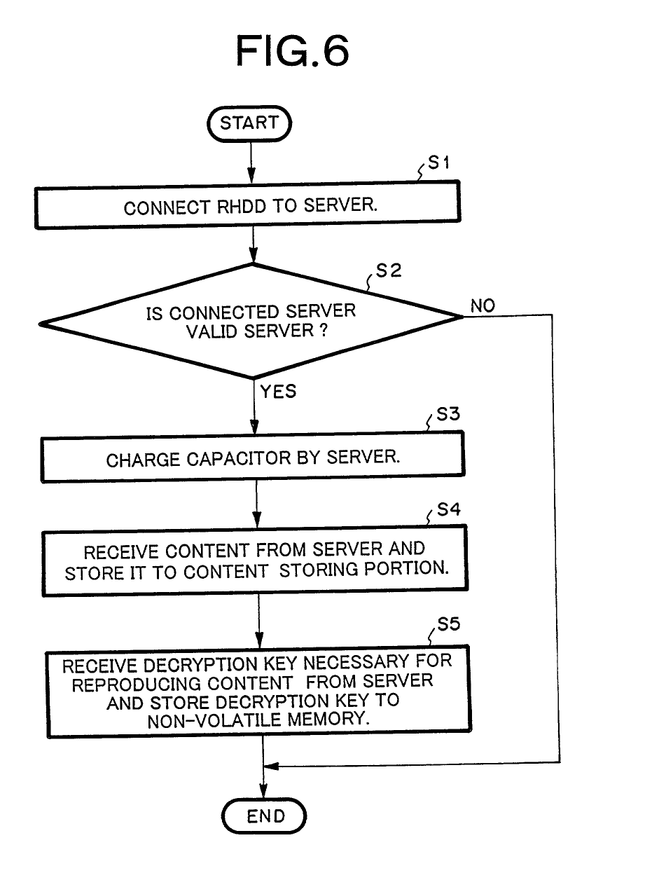

Next, with reference to a flow chart shown in FIG. 6, the operation of the RHDD 17 will be described.

The server 106 stores an encrypted content and a decryption key necessary for decrypting the encrypted content. The server 106 and the RHDD 17 are connected through the external interface 103 (at step S1). At that point, the RHDD 17 determines whether or not the connected device is a valid server (at step S2). There are many determining methods. As the simplest method, the RHDD 17 determines whether or not the outer shape of the external interface 103 is matched to the server 106. As a complicated method, the controlling portion 102 of the RHDD 17 authenticates the server 106. When the determined result of the external interface 103 or the controlling portion 102 represents that the connected server is not a valid server, the capacitor 105 is not charged. The RHDD 17 completes the process.

When the determined result of the external interface 103 or the controlling portion 102 represents that the server 106 is a valid server, the power of the server 106 is supplied to the capacitor 105 through the external interface 103 and the capacitor 105 is charged (at step S3). In the case that only the outer shape of the external interface 103 is checked, when the RHDD 17 is connected to the server 106, the power of the server 106 is supplied to the capacitor 105 through the external interface 103 and the capacitor 105 is charged. In other cases, the controlling portion 102 causes the external interface 103 to supply the power to the capacitor 105. As a result, the capacitor 105 is charged.

Thereafter, the controlling portion 102 receives the encrypted content from the server 106 through the external interface 103 and stores the encrypted content to the content storing portion 101 (at step S4). Likewise, the controlling portion 102 receives the decryption key necessary for reproducing the content from the server 106 through the external interface 103 and stores the decryption key to the non-volatile memory 104 (at step S5).

The RHDD 17 to which the content has been written by the server 106 is connected to the reproducing device of the user. Thereafter, the reproducing device reproduces the content.

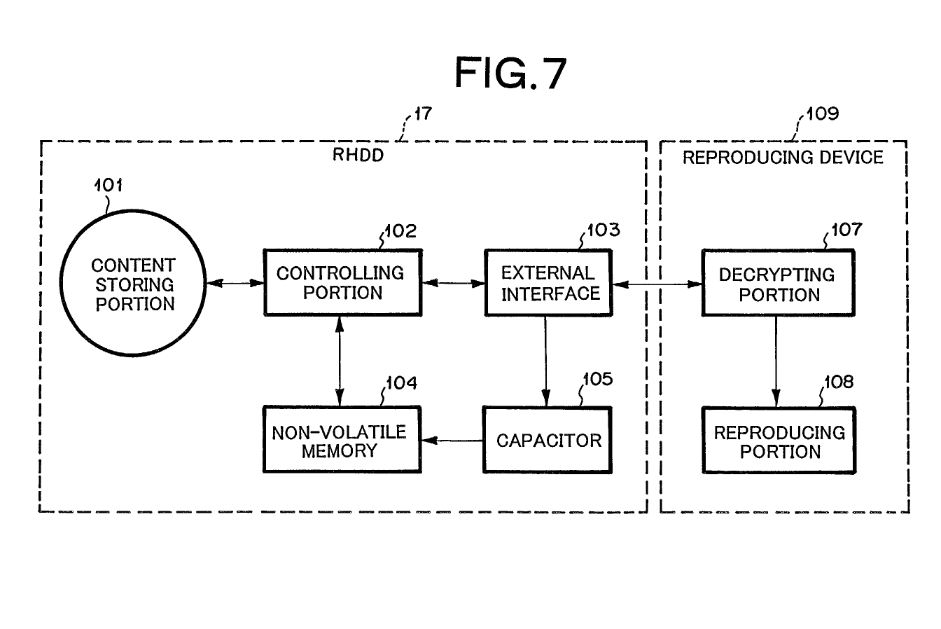

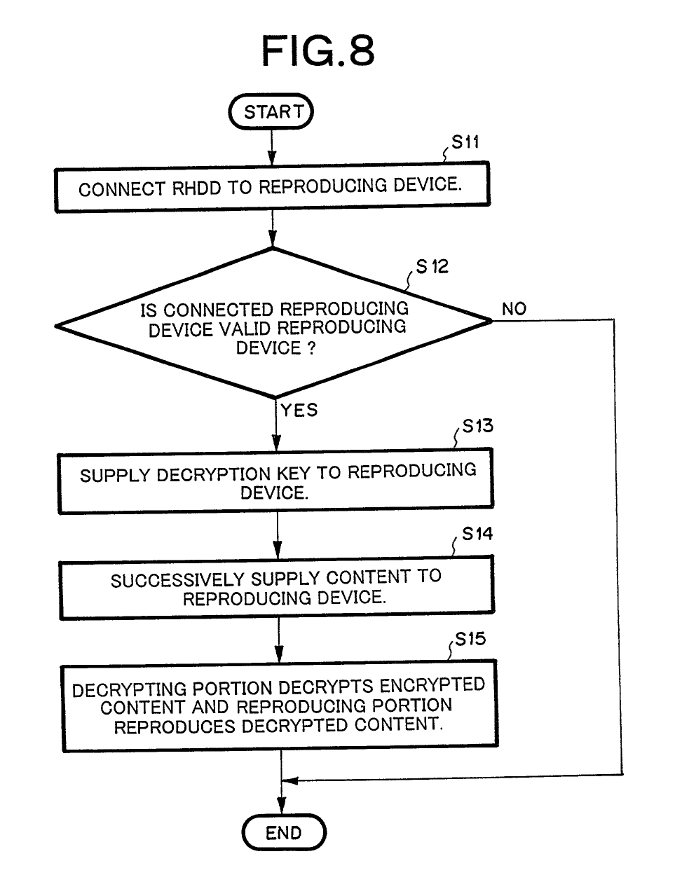

FIG. 7 is a block diagram showing the structure in the case that the RHDD 17 is connected to a reproducing device 109. FIG. 8 is a flow chart showing the operation in the case.

First of all, the RHDD 17 is connected to the reproducing device 109 (at step S11). Thereafter, the RHDD 17 determines whether or not the connected device is a valid reproducing device (at step S12). The determining method for the reproducing device 109 can be the same as that for the server 106. When the determined result at step S12 represents that the connected device is a valid reproducing device, the controlling portion 102 reads the decryption key from the non-volatile memory 104 and supplies the decryption key to a decrypting portion 107 through the external interface 103 (at step S13). Thereafter, the controlling portion 102 reads the encrypted content from the content storing portion 101 and supplies the encrypted content to the decrypting portion 107 through the external interface 103 (at step S14). The decrypting portion 107 of the reproducing device 109 decrypts the encrypted content. Thereafter, a reproducing portion (displaying device) 108 reproduces the decrypted content (at step S15).

When the connected device is not a valid reproducing device, the power is not supplied to the capacitor 105 of the RHDD 17 through the external interface 103. Thus, the power charged in the capacitor 105 of the RHDD 17 decreases. When a predetermined time period elapses, the power charged in the capacitor 105 becomes lower than the backup voltage for the data stored in the non-volatile memory 104. Thus, the decryption key stored in the non-volatile memory 104 is lost. Although the encrypted content is stored in the content storing portion 101, since the decryption key necessary for decrypting the encrypted content is lost, even if the RHDD 17 is connected to the reproducing device 109, it cannot reproduce the content. In such a manner, after a predetermined time period elapses, the content cannot be reproduced. The predetermined time period depends on both the capacitance of the capacitor and the amount of current that flow for backing up the non-volatile memory 104. Thus, by properly selecting the capacitance of the capacitor 105, the backup period can be controlled.

In the above-described operation, an encrypted content and a decryption key are supplied from the server 106 to the RHDD 17. Alternatively, after an encrypted content is stored to the RHDD 17, only a decryption key may be received from the server 106 and stored to the non-volatile memory 104. In FIG. 7, for simplicity, the controlling portion 102 and the non-volatile memory 104 are described as different blocks. Alternatively, the controlling portion 102 may contain the non-volatile memory 104. In this case, a bus that connects the controlling portion 102 and the non-volatile memory 104 is not exposed. Thus, data of the nonvolatile memory can be properly prevented from being copied.

The RHDD 17 may use control data for controlling the content reading operation of the controlling portion 102 instead of the above-described decryption key. Next, the operation in such a case will be described. In this case, since the structure is not changed, with reference to FIG. 5, the operation will be described.

The operation of the controlling portion 102 can be roughly divided into an operation for reading a content from the content storing portion 101 and the other operation. The control algorithm for the other operation is stored in the non-volatile memory 104.

When the RHDD 17 is connected to the server 106, the RHDD 17 determines whether or not the server 106 is a valid server. When the determined result represents that the connected server is a valid server, the capacitor 105 is charged through the external interface 103. Thereafter, a reading control algorithm for reading a content from the content storing portion 101 is received from the server 106 and stored to the non-volatile memory 104.

When the controlling portion 102 needs to read a content from the content storing portion 101, the controlling portion 102 references the control algorithm of the non-volatile memory 104 and reads the content from the content storing portion 101. However, unless the RHDD 17 is connected to the server, the power charged in the capacitor 105 decreases. When a predetermined time period elapses, the reading control algorithm stored in the non-volatile memory 104 is lost. Although the content storing portion 101 stores the content, since the reading control algorithm for reading the content is lost, even if the RHDD 17 is connected to the reproducing device, the content cannot be reproduced. Thus, when a predetermined time period elapses, the content cannot be reproduced.

When the above-described control algorithm is used to reproduce a content, it is not necessary to encrypt the content stored in the content storing portion 101. In this case, an MPEG (Moving Picture Experts Group) decoder portion is disposed in the RHDD 17 so as to prevent the content data from flowing outside. Thus, content data that is not encrypted can be prevented from flowing outside. As information necessary for reproducing a content, a reading control parameter such as a disk format parameter may be used instead of the reading control algorithm.

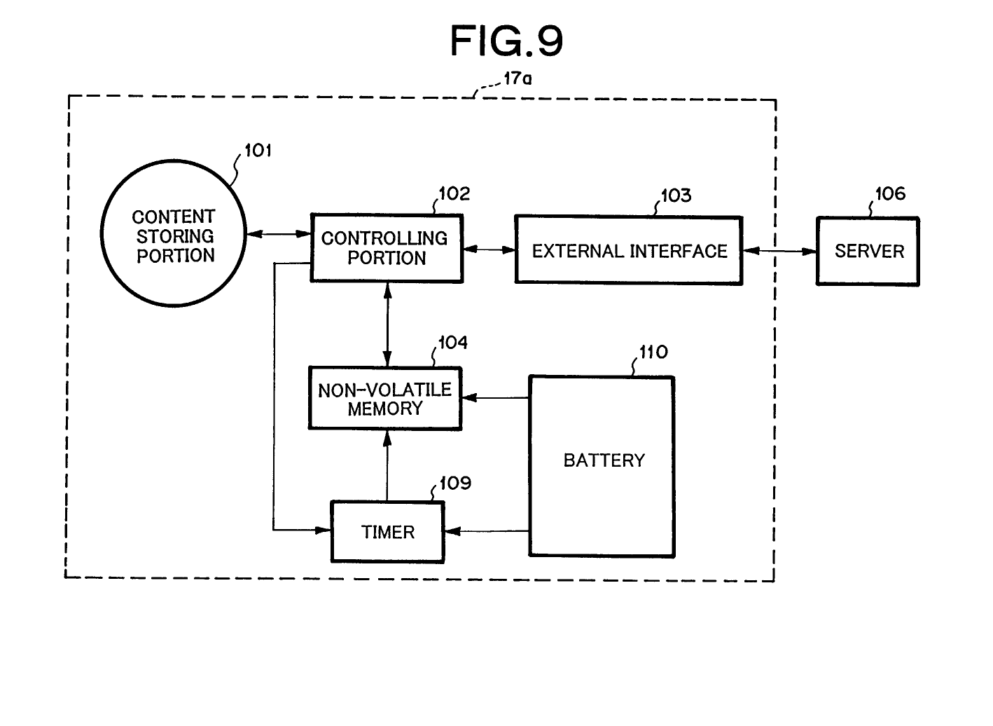

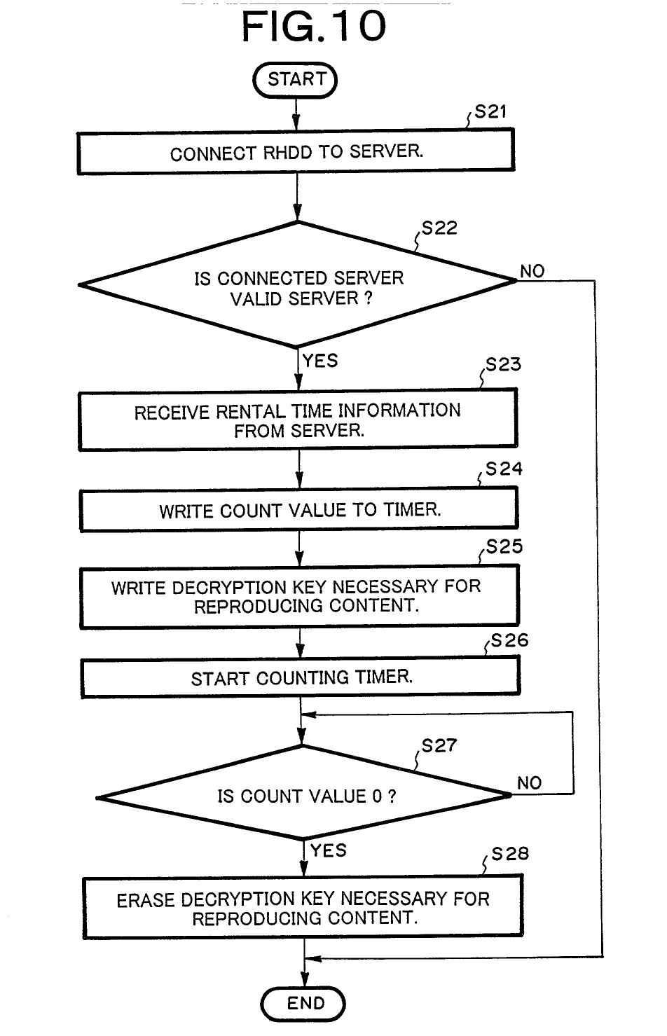

FIG. 9 is a block diagram showing an example of a second structure of the RHDD. FIG. 10 is a flow chart showing the operation of the RHDD shown in FIG. 9. Referring to FIGS. 9 and 10, a server 106 stores rental time information of a content. The server 106 and an RHDD 17a are connected through an external interface 103 (at step S21). At that point, the RHDD 17a determines whether or not the connected device is a valid server (at step S22). Since the determining method is the same as the above-described method, the description thereof is omitted.

When the determined result at step S22 represents that the connected device is a valid server, a controlling portion 102 receives the rental time information from the server 106 (at step S23). The rental time information may be time data such as 2 days or 48 hours. Alternatively, the rental time information may be a timer count value such as 1728000. When the controlling portion 102 receives time data as the rental time information, the controlling portion 102 converts the time data into a timer value for a timer 109. The controlling portion 102 sets the converted timer value to the timer 109 (at step S24). The controlling portion 102 receives a content and a decryption key necessary for reproducing the content from the server 106 through the external interface 103. The controlling portion 102 stores the received content to a content storing portion 101. In addition, the controlling portion 102 stores the decryption key to a non-volatile memory 104 (at step S25). Thereafter, the controlling portion 102 causes the timer 109 to count down (at step S26).

When the timer 109 starts counting down, the controlling portion 102 determines whether or not the counter value of the timer 109 is 0 (at step S27). When the counter value becomes 0, the timer 109 sends a command for causing the non-volatile memory 104 to erase the decryption key stored in the non-volatile memory 104 (at step S28). As the erasing method, a circuit that writes 0s to a particular area of the non-volatile memory 104 may be disposed in the timer 109. Alternatively, a mechanism that turns off a switch of a power line connected from a battery 110 to the non-volatile memory 104 may be disposed.

In the structure shown in FIG. 9, for simplicity, the controlling portion 102, the non-volatile memory 104, and the timer 109 are described as different blocks. Alternatively, the non-volatile memory 104 and the timer 109 may be disposed in the controlling portion 102. In this case, the erase command that is sent from the timer 109 to the non-volatile memory 104 can be prevented from being falsified. As a result, the erasing operation can be securely performed.

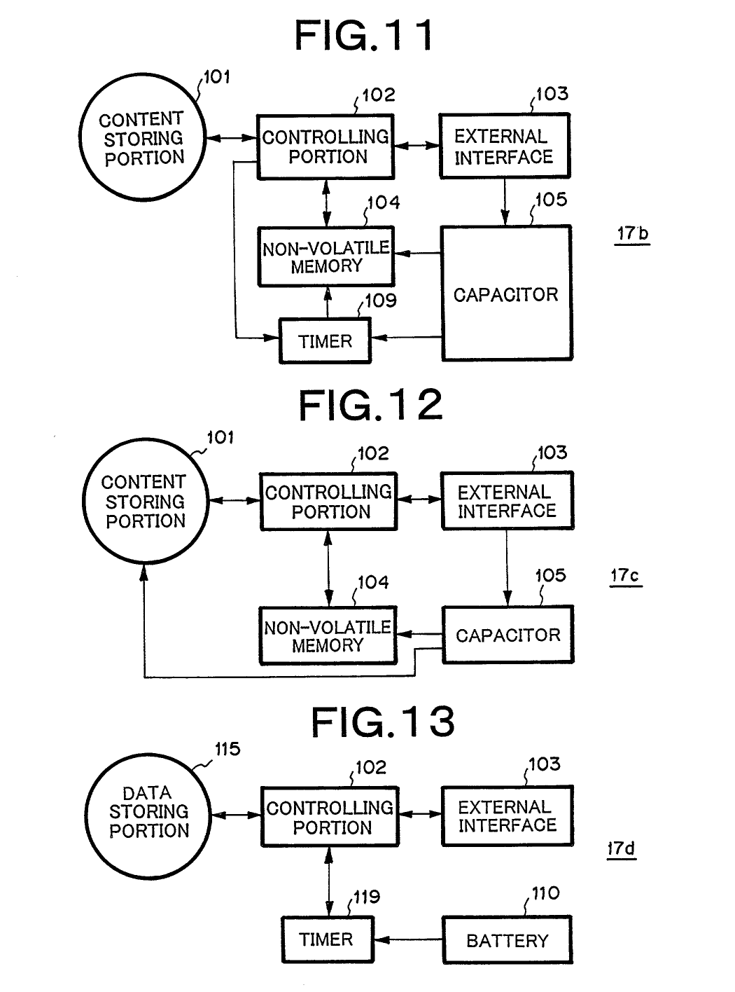

FIG. 11 is a block diagram showing an example of a third structure of the RHDD. Referring to FIG. 11, the battery 110 of the RHDD 17a shown in FIG. 9 is substituted with a capacitor 105. The capacitor 105 backs up the non-volatile memory 104 and the timer 109. The structure of the RHDD 17b shown in FIG. 11 is the same as the structure of the RHDD 17a shown in FIG. 9 except that a power is supplied from the server to the capacitor 105 through the external interface 103 under the control of the controlling portion 102.

In the example of the third structure, the capacitance of the capacitor 105 is selected so that the backup period becomes longer than the setup time of the timer 109. Thus, even if a large value is mistakenly set to the timer 109, it becomes impossible to reproduce a content in a shorter time than the structure in which the content is backed up by the battery 110. Consequently, a situation in which the content is reproduced for a long time can be prevented.

In the above-described structures of the RHDDs, the content storing portion 101 is a non-volatile medium. Alternatively, the content storing portion 101 may be composed of a non-volatile memory. The content storing portion 101 may be backed up by a battery or a capacitor as a modification of each of the above-described structures. FIG. 12 is a block diagram showing an example of the structure of a fourth structure of the RHDD. Referring to FIG. 12, in an RHDD 17c, a content storing portion 101 is composed of a non-volatile memory. A capacitor 105 also backs up the power of the content storing portion 101. Thus, when the voltage of the capacitor 105 becomes low, not only a decryption key stored in a non-volatile memory 104, but a content stored in the content storing portion 101 is erased. Thus, unless the capacitor 105 is properly charged, when a predetermined time period elapses, the content cannot be reproduced. In FIG. 12, for simplicity, the content storing portion 101 and the non-volatile memory 104 are described as different devices. Alternatively, the content storing portion 101 and the non-volatile memory 104 may be accomplished as one device.

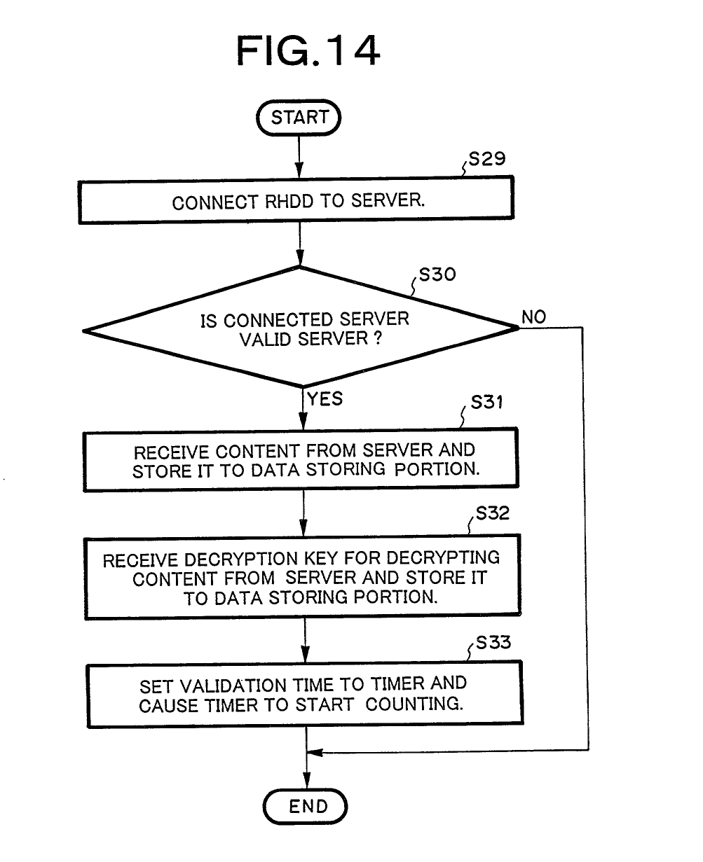

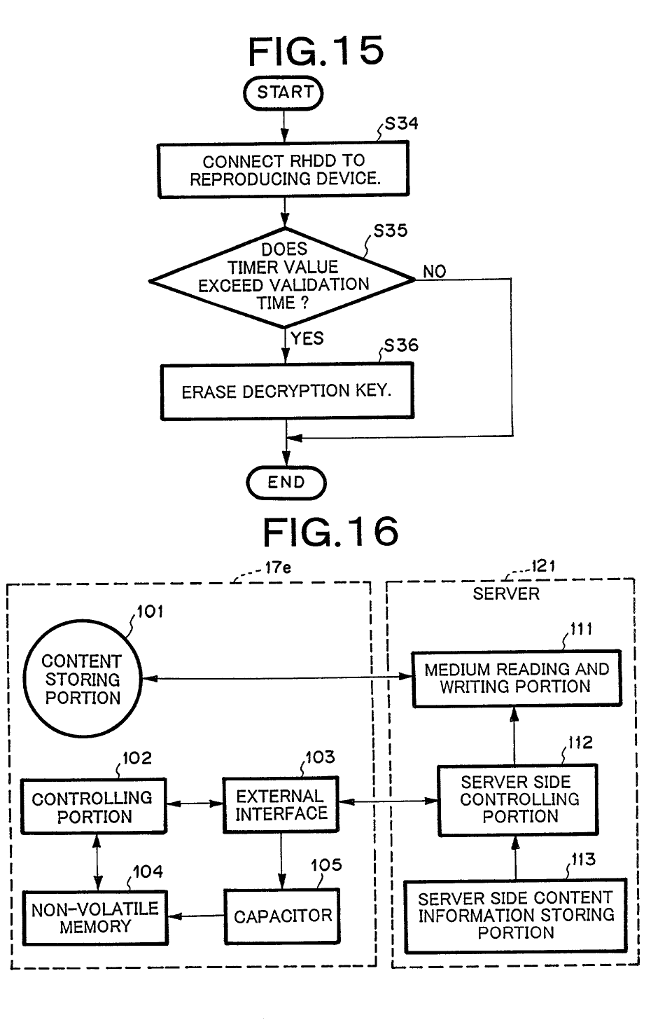

FIG. 13 is a block diagram showing an example of a fifth structure of the RHDD. FIGS. 14 and 15 are flow charts showing the operation of the RHDD shown in FIG. 13.

A server and an RHDD 17d are connected through an external interface 103 (at step S29). At that point, the RHDD 17d determines whether or not the connected device is a valid server (at step S30). Since the determining method is the same as the above-described method, the description thereof is omitted.

When the determined result at step S30 represents that the connected device is a valid server, a controlling portion 102 receives an encrypted content from the server through an external interface 103 and stores the content to a data storing portion 115 (at step S31). Likewise, the controlling portion 102 receives a decryption key from the server through the external interface 103 and stores the received decryption key to the data storing portion 115 (at step S32). Thereafter, the controlling portion 102 receives time information as validation time for the content from the server, sets the received validation time to a timer 119, and causes the timer 119 to start counting (at step S33). It should be noted that the sequence of steps S31 to S33 may be changed.

Once the controlling portion 102 receives the validation time information from the server, writes the validation time information to the timer 119, and causes the timer 119 to start counting, since the timer 119 is backed up by a battery 110, even if the RHDD 17d is disconnected from the server, the timer 119 continues to count. When the timer 119 is a count-down timer, if the count value becomes 0, the timer 119 stops counting.

When the timer 119 is a count-up timer, if the count value becomes a value corresponding to the validation time, the timer 119 stops counting and represents that the validation time elapsed.

FIG. 15 is a flow chart showing a first operation performed in the case that the RHDD 17d is connected to a reproducing device of a user. First of all, the RHDD 17d is connected to the reproducing device (at step S34). At that point, the RHDD 17d receives a main power from the reproducing device. Thereafter, the controlling portion 102 of the RHDD 17d determines whether or not the timer value of the timer 119 exceeds the validation time (at step S35). When the timer value exceeds the validation time, the controlling portion 102 erases the decryption key stored in the data storing portion 115. When the timer value does not exceed the validation time, the reproducing device performs the content reproducing operation. Since the content reproducing operation is the same as the above-described operation (at steps S11 to S15), the description thereof is omitted.

In the structure shown in FIG. 13, as a backup power for the timer 119, the battery 110 is used. Alternatively, a capacitor may be used. In this case, the capacitor is charged by the server or the reproducing device.

In such a manner, when the timer value exceeds the validation time, immediately after the main power is supplied to the RHDD 17d from the outside, the decryption key stored in the data storing portion is erased. Thus, after the validation time elapses, the decryption key cannot be illegally obtained.

In the above-described structures of the RHDDs, the controlling portion 102 controls the reading and writing operations for the content storing portion 101 or the data storing portion 115. Alternatively, the reading and writing operations for the content storing portion 101 or the data storing portion 115 may be performed by a medium reading and writing portion of a valid server or a valid reproducing device. Thus, in such a modification, the RHDD does not have the medium reading and writing portion. FIG. 16 is a block diagram showing an example of a sixth structure of the RHDD as such a modification. Referring to FIG. 16, a content storing portion 101 is independent of a controlling portion 102. The content storing portion 101 does not have a medium reading and writing portion. In contrast, a server has a medium reading and writing portion 111 that controls the reading and writing operations for the content storing portion 101.

Referring to FIG. 16, a content and information necessary for reproducing the content are stored in a content information storing portion 113 of a server 121. The server side controlling portion 112 reads the content from the server side content information storing portion 113. The controlling portion 112 writes the content to the content storing portion 101 through the medium reading and writing portion 111. On the other hand, the server side controlling portion 112 reads a decryption key from the server side content information storing portion 113 and sends the decryption key to the controlling portion 102 through an external interface 103 of the RHDD 17e. The controlling portion 102 stores the decryption key to a non-volatile memory 104. A capacitor 105 is charged in the above-described manner. Thus, the description of the charging method is omitted.

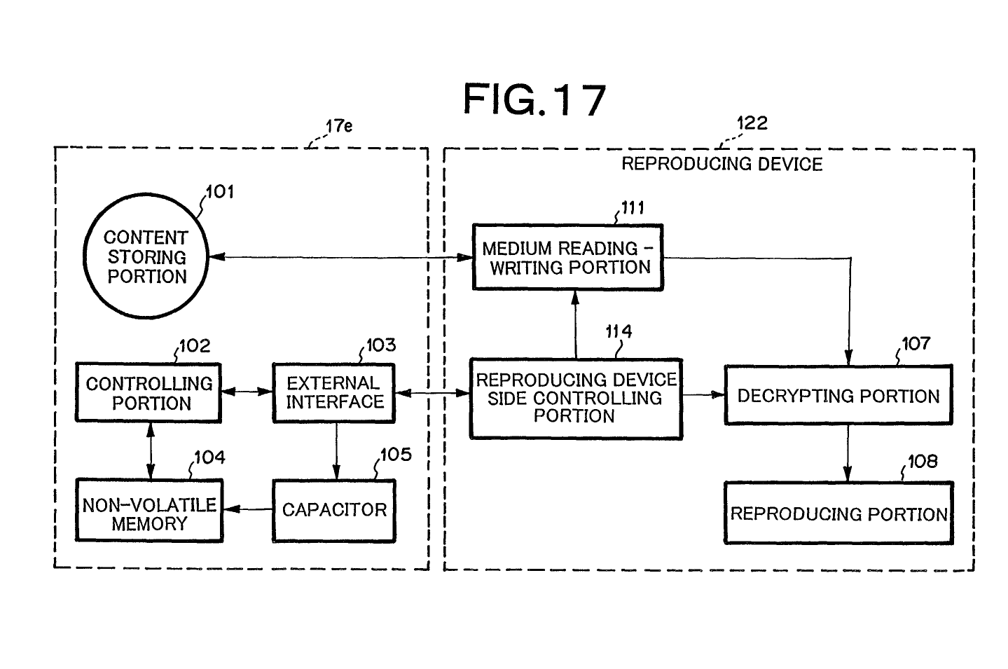

FIG. 17 is a block diagram showing an example of another structure of the reproducing device. A controlling portion 114 of a reproducing device 122 receives decryption key from a non-volatile memory 104 having a read restricting function through the controlling portion 102 and the external interface 103 and sends the decryption key to a decrypting portion 107. When the non-volatile memory 104 stores control data for controlling the medium reading and writing portion 111, the reproducing device side controlling portion 114 sends the data to the medium reading and writing portion 111. Thereafter, the reproducing device 122 reads a content from a content storing portion 101 of the a medium having the content reproduction restricting mechanism. The decrypting portion 107 decrypts the content. Thereafter, the reproducing portion 108 reproduces the content. However, when the backup period of the capacitor 105 elapsed, even if an invalid medium contains a copied content, since the decryption key was erased, the reproducing device cannot reproduce the content.

According to the structures of the above-described RHDDs 17 to 17e, when a predetermined period elapsed, since information necessary for reproducing a content is erased, the content cannot be reproduced. Thus, when the RHDDs 17 to 17e are used for a rental system, customers do not need to return content mediums to rental stores. When a timer is disposed, the time at which information necessary for reproducing a content can be accurately set.

In addition, when the connected server is a valid server, the capacitor is charged. Thus, the time at which information necessary for reproducing a content is erased can be prevented from being illegally prolonged by a false server. When a content has been stored to an RHDD, only information necessary for reproducing the content is received from the server. Thus, the operation time is remarkably reduced. In addition, when medium read-write control data is used as information necessary for reproducing the content, after a predetermined period elapses, the control data is lost. At that point, the content cannot be read. Thus, the risk that the content is illegally read is remarkably reduced. Alternatively, only the timer may be backed up by an internal battery (or capacitor). In this case, when the validation time elapsed, immediately after the main power is supplied from the outside, a decryption key stored in the data storing portion is erased. Thus, the capacity of the internal battery or the capacitor can be decreased. As a result, the cost of the RHDD can be reduced.

Alternatively, when a server or a reproducing device has a medium reading-writing portion, the structure of the medium having the content reproduction restricting mechanism can be simplified. Thus, the cost of the RHDD can be remarkably reduced. In addition, since control data for controlling the medium reading-writing portion of the reproducing device can be received from the medium having the content reproduction restricting mechanism, a content cannot be read from an invalid medium. Thus, the risk that a content is illegally reproduced can be remarkably reduced.

<Third Embodiment>

Next, a third embodiment of the present invention will be described. According to the third embodiment, an RHDD is composed of only a record medium for recording a content. In addition, according to the third embodiment, an IC card, a public key, and a secret key are used so as to strictly secure a content stored in the RHDD.

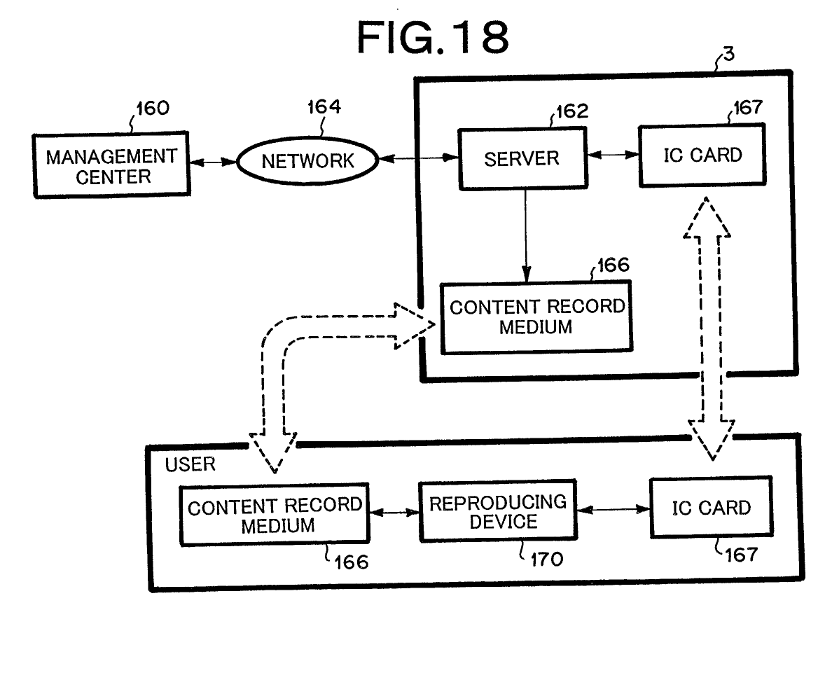

FIG. 18 is a block diagram showing the structure of the third embodiment. According to the third embodiment, a management center 160 is disposed. The management center 160 manages a plurality of rental business operators 3. The management center 160 is connected to a downloading server 162 of each of the rental business operators 3 through a network 164. The management center 160 corresponds to the video software duplicator 2 shown in FIG. 3. A content record medium 166 and an IC card 167 are connected to the server 162. A reference numeral 170 is a reproducing device disposed in the house of each user. The content record medium 166 and the IC card 167 are connected to the reproducing device 170. The content is reproduced from the content record medium 166.

The management center 160 stores content encryption keys for individual contents, public key certificates of all IC cards, public key certificates of all reproducing devices, and pair information of all IC cards and all reproducing devices. The management center 160 receives an IC card public key certificate from an IC card 167 and a public key certificate of a reproducing device through a server 162 and determines whether or not the IC card 167 and the reproducing device are valid.

After the management center 160 mutually authenticates the IC card 167 through the server 162, the management center 160 can deliver a content encryption key and rental period information to the IC card 167 through the server 162 corresponding to a predetermined process. The server 162 stores a content that has been encrypted using a content key stored in the management center 160. The user can perform an operation for renting a content through the server 162. The server 162 can download an encrypted content to a content record medium 166 corresponding to predetermined processes of the management center 160 and the IC card 167.

The IC card 167 can download a content encryption key (of which a content has been encrypted) and rental period information through the server 162 and store the content key in the rental period. When the rental period elapsed, the IC card 167 can erase the content key. In addition, the IC card 167 can mutually authenticate a reproducing device 170 of the user. The IC card 167 can deliver the content key in the rental period corresponding to a predetermined process. The content record medium 166 can record a content stored in the server 162 corresponding to predetermined processes of the management center 160 and the IC card 167. After a predetermined process is performed for the reproducing device 170 of the user, content data is read to the content record medium 166 under the control of the reproducing device 170.

After the reproducing device 170 of the user authenticates the IC card 167, corresponding to a predetermined process, the reproducing device 170 of the user stores the content key transmitted from the IC card 167 in the rental period. Until the rental period elapses or the power is turned off, the reproducing device 170 can store the content key. In addition, the reproducing device 170 can read the encrypted content from the content record medium 166 corresponding to a predetermined process, decrypt the encrypted content data using the content encryption key that is read from the IC card 167, and reproduce the content in the rental period.

Next, the operations of the devices shown in FIG. 18 will be successively described.

The IC card 167 is pre-connected to the reproducing device 170. The IC card 167 and the reproducing device 170 are mutually authenticated. When the IC card 167 is valid, it stores a reproducing device public key certificate. Thereafter, the user takes the IC card 167 and the content record medium 166 to a rental store and connects them to the server 162. When the IC card 167 is connected to the server 162, it reads an IC card public key certificate from the IC card 167 and transmits a request for mutually authenticating the IC card 167 to the management center 160 along with the IC card public key certificate.

After the management center 160 determines whether or not the IC card public key certificate is valid, the management center 160 mutually authenticates the IC card 167. Thereafter, the server 162 reads a reproducing device public key certificate and transfers the reproducing device public key certificate to the management center 160. The management center 160 determines whether or not the reproducing device public key certificate is valid. When the user inputs the title name of a content that he or she wants to rent and the rental period thereof to the server 162, the server 162 transmits the title name of the content and the rental period to the IC card 167 and reads the reproduction information and the signature thereof from the IC card 167. The server 162 transmits the reproduction information and the signature data thereof as data that requires a content encryption key to the management center 160.

When the determined result represents that the data is valid corresponding to the reproduction information and the signature thereof received from the server 162, the management center 160 encrypts the content encryption key corresponding to the content title name using the reproducing device public key and transmits the signature data to the IC card 167 through the server 162. The IC card 167 determines whether or not the content encryption key and the signature data are valid. When the determined result represents that the content encryption key and the signature data are valid, the IC card 167 stores the content key in the rental period.

Thereafter, the server 162 transfers the encrypted content to the content record medium 166 corresponding to a predetermined process. After the user pays the rental fee for the content to the rental store, he or she receives the IC card 167 and the content record medium 166 from the rental store. Thereafter, the user connects the IC card 167 and the content record medium 166 to the reproducing device 170 of the user. The reproducing device 170 mutually authenticates the IC card 167. When the authenticated result represents that they are valid, the reproducing device 170 can read the content encryption key, the rental information, and the signature data from the IC card 167.

The reproducing device 170 determines whether or not the data is valid using the content key, the rental information, and the signature data. When the determined result of the reproducing device 170 represents that the data is valid, the reproducing device 170 stores the content key in the rental period or until the power is turned off. The reproducing device 170 reads the encrypted content from the content record medium 166, decrypts the encrypted content using the content key, and reproduces the content in the rental period or until the power is turned off.

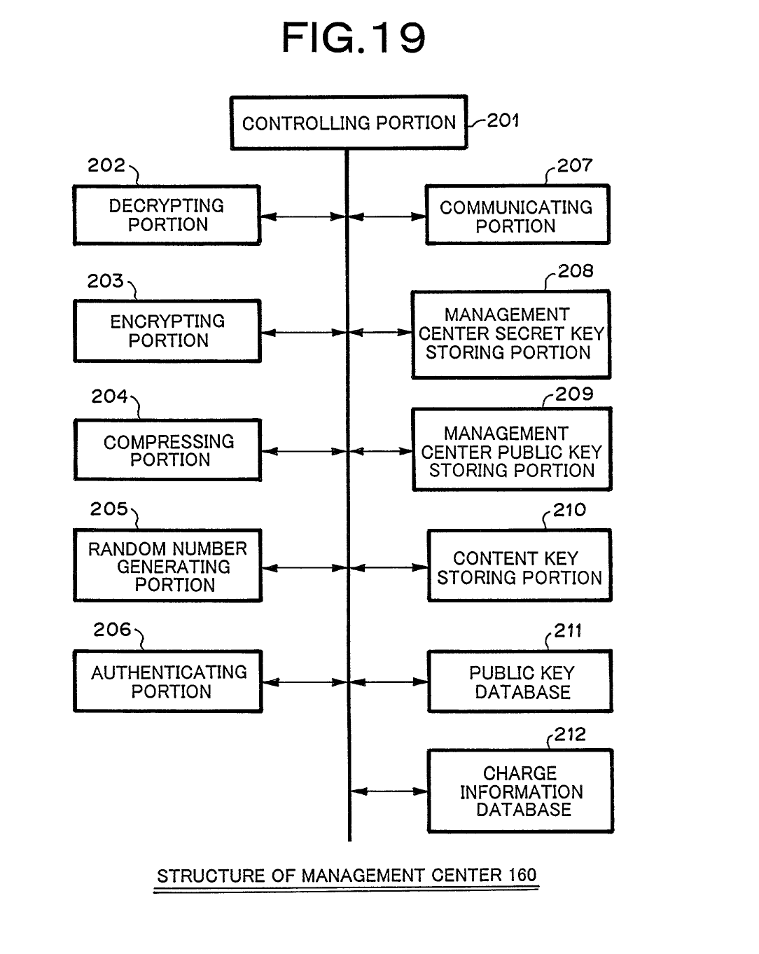

FIG. 19 shows an example of a detailed structure of the management center 160. The management center 160 is composed of a controlling portion 201, a decrypting portion 202, an encrypting portion 203, a compressing portion 204, a random number generating portion 205, an authenticating portion 206, a communicating portion 207, a management center secret key storing portion 208, a management center public key storing portion 209, a content key storing portion 210, a public key database 211, and a charge information database 212. The management center secret key storing portion 208 stores a secret key that only the management center 160 has. The management center public key storing portion 209 stores a management center public key paired with the management center secret key. The content key storing portion 210 stores a common key encrypted for each content. The public key database 211 stores public key certificates of all IC cards and all reproducing devices and pair information of all the IC cards and all the reproducing devices. The charge information database 212 stores the title names of contents, the rental periods, and the rental fees of contents that users rented.

When the decrypting portion 202 receives encrypted data from the server 162 of the rental store through the communicating portion 207, the decrypting portion 202 can decrypt the encrypted data using the management center secret key stored in the management center secret key storing portion 208 or the IC card public keys and the reproducing device public key stored in the public key database 211 under the control of the controlling portion 201. When data is transmitted to the server 162 of the rental store through the communicating portion 207, the encrypting portion 203 can encrypt the data using the management center secret key stored in the management center secret key storing portion 208 or the IC card public key and the reproducing device public key stored in the public key database 211 under the control of the controlling portion 201. The compressing portion 204 can compress any data using the hash function under the control the controlling portion 201. The random number generating portion 205 can generate a random number under the control of the controlling portion 201. When a mutual authenticating operation is performed, the authenticating portion 206 can collate a transmitted random number with a received random number. In addition, the authenticating portion 206 can collate received data with signature data.

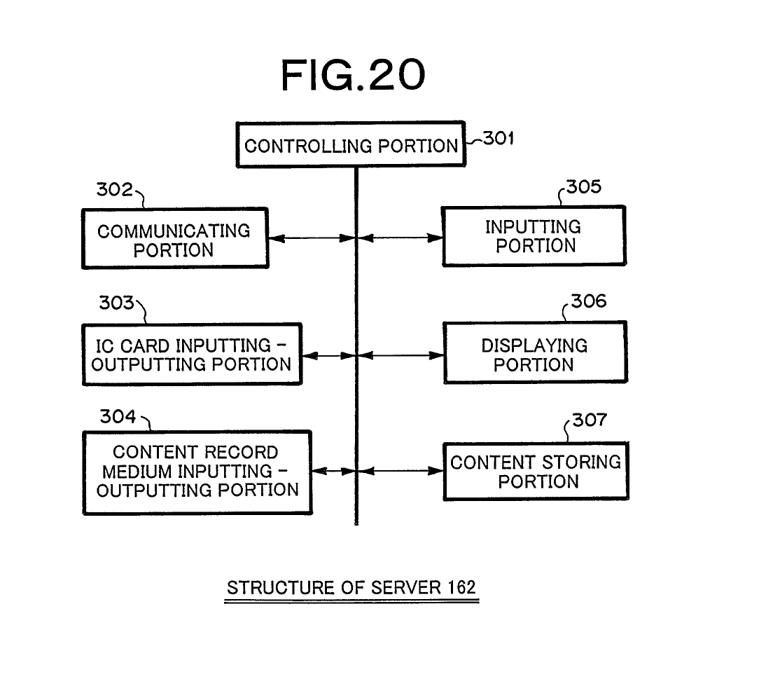

FIG. 20 is a block diagram showing a detailed structure of the server 162 shown in FIG. 18. The server 162 is composed of a controlling portion 301, a communicating portion 302, an IC card inputting-outputting portion 303, a content record medium inputting-outputting portion 304, an inputting portion 305, a displaying portion 306, and a content storing portion 307. The communicating portion 302 can communicate with the management center 160 through the network 164 such as the Internet under the control of the controlling portion 301. The IC card inputting outputting portion 303 can communicate with the IC card 167 under the control of the controlling portion 301. The content record medium inputting-outputting portion 304 can output content data stored in the content storing portion 307 to the content record medium 166 under the control of the controlling portion 301. The inputting portion 305 is a user interface through which the user can select a content that he or she will rent and the rental period thereof. The displaying portion 306 is a user interface that displays the title name of the content that the user will rent and the rental period thereof. The content storing portion 307 stores the encrypted content.

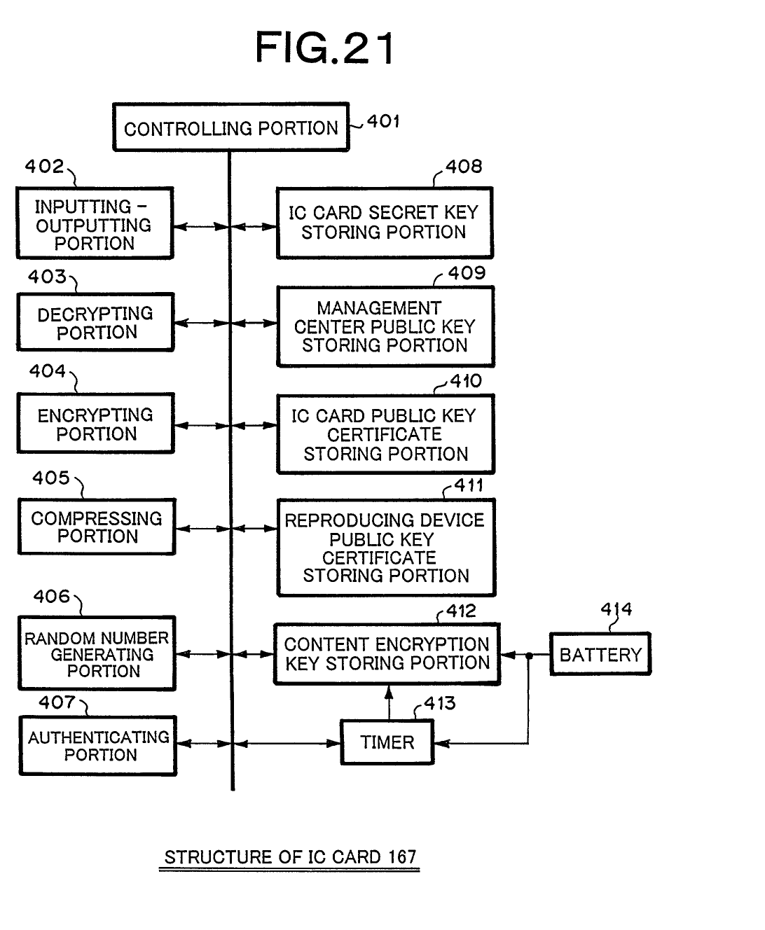

FIG. 21 shows a detailed structure of the IC card 167 shown in FIG. 18.

The IC card 167 is composed of a controlling portion 401, an inputting-outputting portion 402, a decrypting portion 403, an encrypting portion 404, a compressing portion 405, a random number generating portion 406, an authenticating portion 407, an IC card secret key storing portion 408, a management center public key storing portion 409, an IC card public key certificate storing portion 410, a reproducing device public key certificate storing portion 411, a content encryption key storing portion 412, a timer 413, and a battery 414.

The IC card secret key storing portion 408 stores a secret key. The management center public key storing portion 409 stores a management center public key. The IC card public key certificate storing portion 410 stores an IC card public key certificate issued by the management center 160. The reproducing device public key certificate storing portion 411 stores a reproducing device public key certificate issued by the management center 160 and read from the reproducing device 170. The content encryption key storing portion 412 is backed up by the battery 414. The content encryption key storing portion 412 can store a content encryption key delivered from the management center 160 until the timer value of the timer 413 becomes a predetermined value. The timer 413 is backed up by the battery 414. The timer value of the timer 413 varies from the initial value delivered from the management center 160 as time elapses. When the timer value of the timer 413 becomes a predetermined value, the timer 413 causes data of the content encryption key storing portion 412 to be cleared.

When the decrypting portion 403 receives encrypted data from the server 162 of the rental store through the inputting-outputting portion 402 or from the reproducing device 170 of the user through the inputting-outputting portion 402, the decrypting portion 403 can decrypt the encrypted data using the IC card secret key or the management center public key under the control of the controlling portion 401. When data is transmitted to the server 162 of the rental store or the reproducing device 170 of the user through the inputting-outputting portion 402, the encrypting portion 404 can encrypt the data using the IC card secret key or the reproducing device public key under the control of the controlling portion 401. The compressing portion 405 can compress any data using the hash function under the control of the controlling portion 401. The random number generating portion 406 can generate a random number under the control of the controlling portion 401. When a mutual authenticating operation is performed, the authenticating portion 407 can collate a transmitted random number with a received random number. In addition, the authenticating portion 407 can collate received data with signature data.

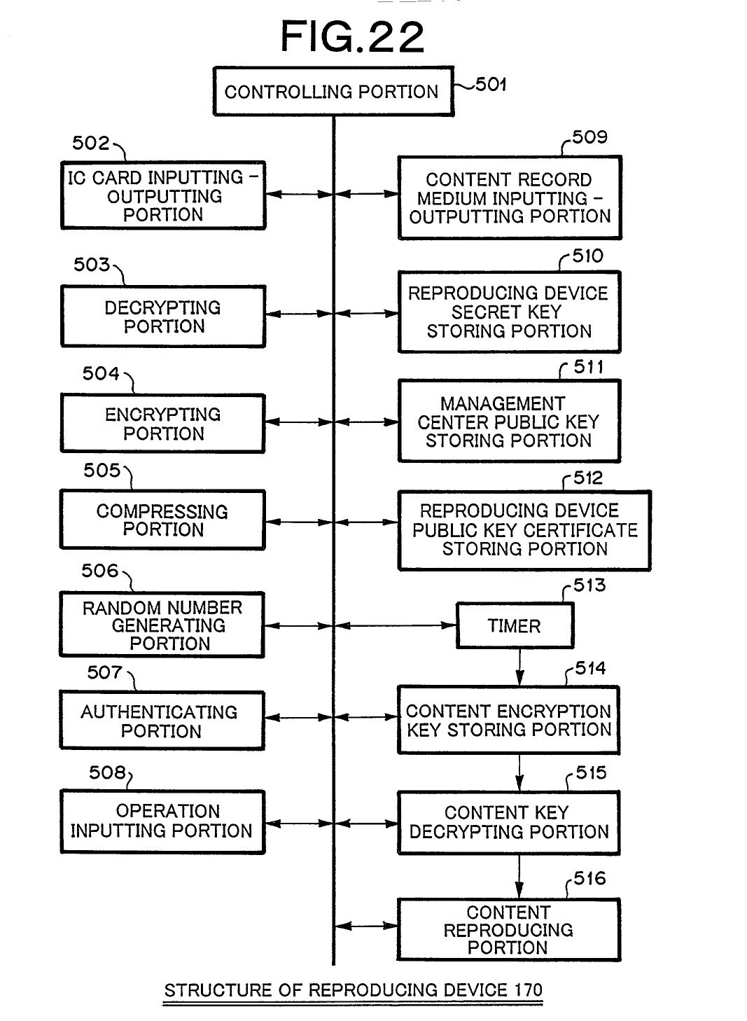

FIG. 22 is a block diagram showing a detailed structure of the reproducing device 170 shown in FIG. 18.

The reproducing device 170 is composed of a controlling portion 501, an IC card inputting-outputting portion 502, a decrypting portion 503, an encrypting portion 504, a compressing portion 505, a random number generating portion 506, an authenticating portion 507, a content record medium inputting-outputting portion 509, a reproducing device secret key storing portion 510, a management center public key storing portion 511, a reproducing device public key certificate storing portion 512, a timer 513, a content encryption key storing portion 514, a content key decrypting portion 515, and a content reproducing portion 516.

The reproducing device secret key storing portion 510 stores a secret key of the reproducing device 170. The management center public key storing portion 511 stores a management center public key paired with a management center secret key corresponding to a predetermined process. The reproducing device public key certificate storing portion 512 stores a reproducing device public key certificate issued by the management center 160. A predetermined timer value that represents the rental period that the controlling portion 501 reads from the IC card 167 through the IC card inputting-outputting portion 502 is set to the timer 513. The timer value of the timer 513 varies as time elapses. When the timer value of the timer 513 becomes the predetermined value of the end of the rental period, the timer 513 causes the data stored in the content encryption key storing portion 514 to be cleared. The content encryption key storing portion 514 stores a content encryption key that the controlling portion 501 reads from the IC card 167 through the IC card inputting-outputting portion 502. When the decrypting portion 503 receives encrypted data and digital certificate data from the IC card 167 through the IC card inputting-outputting portion 502, the decrypting portion 503 can decrypt the encrypted data using the reproducing device secret key or the management center public key under the control of the controlling portion 501.

When data is transmitted to the IC card 167 through the IC card inputting-outputting portion 502, the encrypting portion 504 can encrypt the data using the reproducing device secret key under the control of the controlling portion 501. The compressing portion 505 can compress any data using the hash function under the control of the controlling portion 501. The random number generating portion 506 can generate a random number under the control of the controlling portion 501. When a mutual authenticating operation is performed, the authenticating portion 507 can collate a transmitted random number with a received random number. In addition, the authenticating portion 507 can collate received data with signature data.

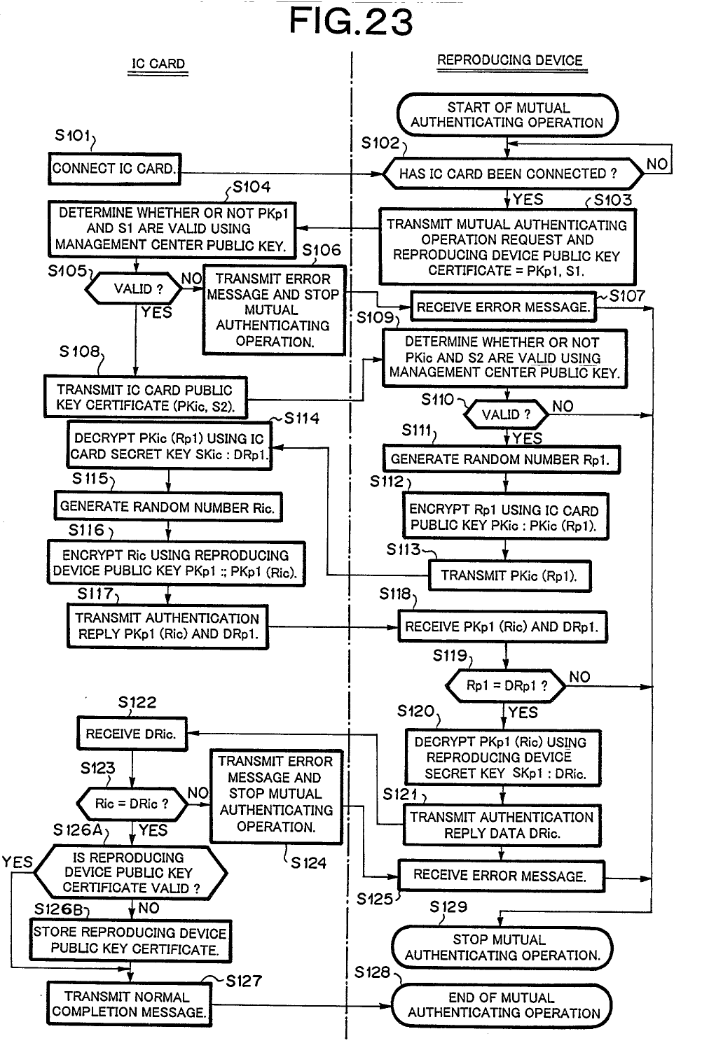

Next, with reference to a flow chart shown in FIG. 23, the mutual authenticating operation of the reproducing device 170 and the IC card 167 will be described.

The mutual authenticating operation is performed (1) before the IC card 167 and the reproducing device 170 are shipped from the factory, (2) when the user uses the system for the first time, (3) when the model of the reproducing device 170 is changed, or (4) when a content is reproduced.

First of all, the IC card 167 is connected to the reproducing device 170 (at step S101). The controlling portion 501 of the reproducing device 170 determines whether or not the IC card 167 has been connected to the reproducing device 170 through the IC card inputting-outputting portion 502. The controlling portion 501 repeats the same process until the IC card 167 come to be connected to the reproducing device 170 (at step S102). When the determined result at step S102 represents that the IC card 167 come to be connected to the reproducing device 170, the controlling portion 501 transmits a reproducing device public key certificate (Pkp1, S1) stored in the reproducing device public key certificate storing portion 512 to the IC card 167 along with a mutual authenticating operation request (at step S103). When the controlling portion 401 of the IC card 167 receives the reproducing device public key certificate (PKp1 and S1) and the mutual authenticating operation request through the inputting-outputting portion 402, the decrypting portion 403 decrypts a signature S1 of the reproducing device public key certificate using a management center public key PKcnt stored in the management center public key storing portion 409 to generate PKcnt (S1). The compressing portion 405 compresses the management center public key PKp1 using the hash function to generate H (PKp1). The authenticating portion 407 collates PKcnt with H (PKp1) (at step S104).

When the determined result at step S105 represents that PKcnt does not match H (PKp1), the controlling portion 401 of the IC card 167 determines that the reproducing device public key certificate is an invalid certificate that has not been issued by the management center 160 and transmits an error message to the reproducing device 170 through the inputting-outputting portion 402 (at step S106). When the controlling portion 501 receives the error message through the IC card inputting-outputting portion 502 (at step S107), the controlling portion 501 stops the mutual authenticating operation (at step S129).

When the determined result at step S105 represents that PKcnt matches H (PKp1), the controlling portion 401 of the IC card 167 determines that the reproducing device public key certificate is a valid certificate that has been issued by the management center 160 and transmits the IC card public key certificate (PKic, S2) stored in the IC card public key certificate storing portion 410 to the reproducing device 170 through the inputting-outputting portion 402 (at step S108). When the controlling portion 501 of the reproducing device 170 receives the IC card public key certificate (PKic, S2) through the IC card inputting-outputting portion 502, the decrypting portion 503 decrypts a signature S2 using the management center public key PKcnt stored in the management center public key storing portion 511 to generate PKcnt (S2). The compressing portion 505 compresses the IC card public key PKp1 using the hash function to generate H (PKp1). The authenticating portion 507 collates PKcnt (S2) with H (PKp1) (at step S109). When the determined result at step S110 represents that PKcnt (S2) does not match H (PKp1), the controlling portion 501 of the reproducing device 170 determines that the IC card public key certificate is an invalid certificate that has not been issued by the management center 160 and stops the mutual authenticating operation (at step S129).

When the determined result at step S110 represents that PKcnt (S5) matches H (PKic), the controlling portion 501 of the reproducing device 170 determines that the public key certificate is a valid certificate that has been issued by the management center 160. The random number generating portion 506 generates a random number Rp1 (at step S111). The controlling portion 501 of the reproducing device 170 causes the encrypting portion 504 to encrypt the random number Rp1 using the IC card public key Pkic to generate PKic (Rp1) (at step S112), and transmit PKic (Rp1) to the IC card 167 through the IC card inputting-outputting portion 502 (at step S113). When the controlling portion 401 of the IC card 167 receives PKic (Rp1) through the inputting-outputting portion 402, the decrypting portion 403 decrypts PKic (Rp1) using the IC card secret key SKic stored in the IC card secret key storing portion 408 to generate DRp1 (at step S114).

Next, the random number generating portion 406 generates a random number Ric (at step S115). The encrypting portion 404 encrypts the random number Ric using the reproducing device public key PKp1 to generate PKp1 (Ric) (at step S116) and transmits PKp1 (Ric) and DRp1 to the reproducing device 170 through the inputting-outputting portion 402 (at step S117). When the controlling portion 501 of the reproducing device 170 receives PKp1 (Ric) and DRp1 from the IC card inputting-outputting portion 502 (at step S118), the authenticating portion 507 collates the random number Rp1 generated by the reproducing device 170 with DRp1 decrypted by the IC card 167 (at step S119). When the determined result at step S119 represents that Rp1 does not match DRp1, the controlling portion 501 of the reproducing device 170 determines that the IC card is an invalid IC card that has an IC card secret key that is not paired with the IC card public key and stops the mutual authenticating operation (at step S129).

When the determined result at step S119 represents that Rp1 matches Drp1, the controlling portion 501 of the reproducing device 170 determines that the IC card is a valid IC card that has an IC card secret key paired with the IC card public key. The decrypting portion 503 decrypts PKp1 (Ric) received at step S118 using the reproducing device secret key SKp1 stored in the reproducing device secret key storing portion 510 to generate DRic (at step S120), and transmits DRic to the IC card 167 through the IC card inputting-outputting portion 502 (at step S121). When the controlling portion 401 of the IC card 167 receives DRic from the inputting-outputting portion 402 (at step S122), the authenticating portion 407 collates the random number Ric generated by the IC card 167 with DRic decrypted by the reproducing device (at step S123). When the determined result at step S123 represents that Ric does not match DRic, the controlling portion 401 of the IC card 167 transmits an error message to the reproducing device 170 through the inputting-outputting portion 402 (at step S124). When the controlling portion 501 of the reproducing device 170 receives the error message from the IC card inputting-outputting portion 502 (at step S125), the controlling portion 501 stops the mutual authenticating operation (at step S129).

When the determined result at step S123 represents that Ric matches DRic, the controlling portion 401 of the IC card 167 compares the content of the reproducing device public key certificate storing portion 411 with the reproducing device public key certificate (PKp1, S1) received at step S104 (at step S126A). When the content of the reproducing device public key certificate storing portion 411 does not match the reproducing device public key certificate (PKp1, S1) received at step S104, the controlling portion 401 stores the public key certificate (PKp1, S1) of the reproducing device 170 received at step S104 to the reproducing device public key certificate storing portion 411 (at step S126B). When the content of the reproducing device public key certificate storing portion 411 matches the reproducing device public key certificate (PKp1, S1) received at step S104, the flow advances to step S127.

Thereafter, the controlling portion 401 of the IC card 167 transmits a mutual authenticating operation normal completion message to the reproducing device 170 through the inputting-outputting portion 402 (at step S127). When the controlling portion 501 of the reproducing device 170 receives the normal completion message through the IC card inputting-outputting portion 502, the controlling portion 501 stops the mutual authenticating operation (at step S128).

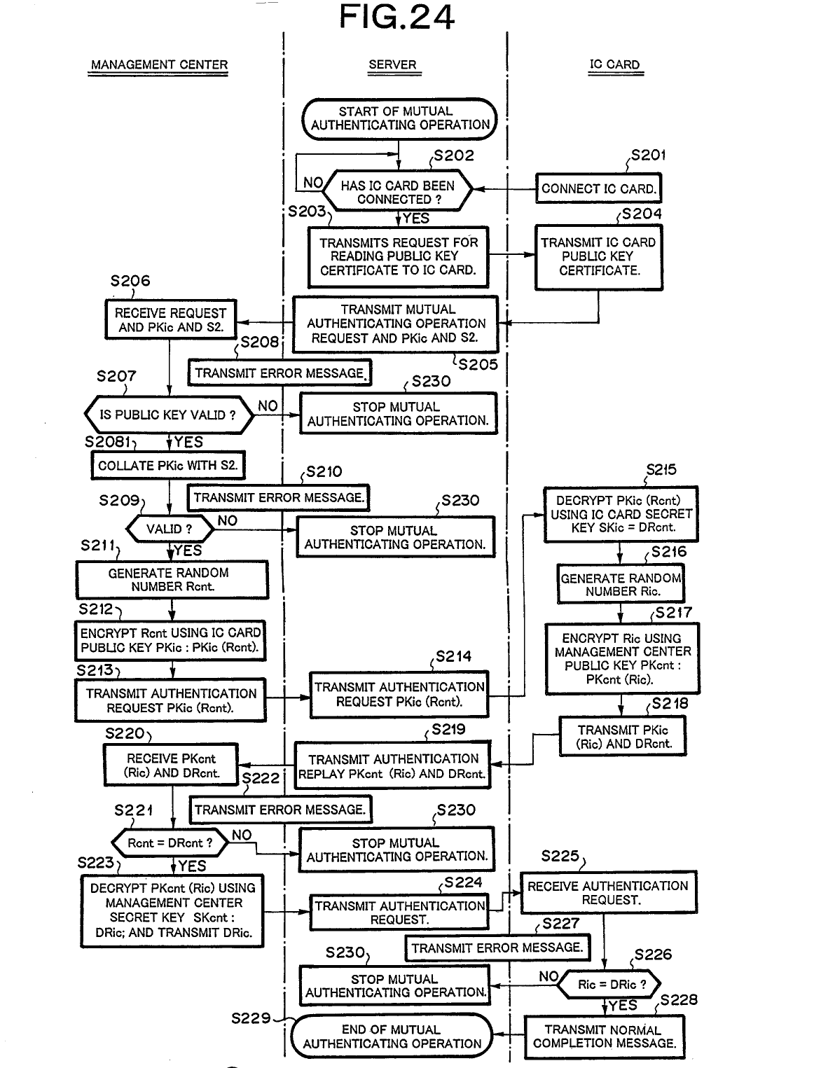

Next, with reference to a flow chart shown in FIG. 24, the mutual authenticating operation of the IC card 167 and the management center 160 shown in FIG. 18 will be described.

The user takes the IC card 167 and the content record medium 166 to a rental store. The IC card 167 and the content record medium 166 are connected to the server 162 of the rental store (at step S201). When the controlling portion 301 of the server 162 determines that the IC card 167 come to be connected to the server 162 through the communicating portion 302 (at step S202), the controlling portion 301 transmits a request for reading the IC card public key certificate to the IC card 167 through the communicating portion 302 so as to perform the mutual authenticating operation (at step S203). When the controlling portion 401 of the IC card 167 receives the request for reading the IC card public key certificate from the inputting-outputting portion 402, the controlling portion 401 transmits an IC card public key certificate (PKic, S2) stored in the IC card public key certificate storing portion 410 to the server 162 through the inputting-outputting portion 402 (at step S204).

When the controlling portion 301 of the server 162 receives the IC card public key certificate (PKic, S2) from the IC card inputting-outputting portion 303, the controlling portion 301 transmits the IC card public key certificate (PKic, S2) and a mutual authenticating operation request to the management center 160 through the communicating portion 302 and the network 164 (at step S205). When the controlling portion 201 of the management center 160 receives the mutual authenticating operation request and the IC card public key certificate (PKic, S2) from the server 162 through the communicating portion 207 (at step S206), the controlling portion 201 searches the public key database 211 for the same IC card public key as the IC card public key PKic in the IC card public key certificate (PKic, S2) from the public key database 211 to determine whether or not the IC card public key PKic is valid (at step S207).

When the determined result at step S207 represents that the IC card public key PKic is invalid or expired, the controlling portion 201 of the management center 160 transmits an error message as a reply of the mutual authenticating operation request from the communicating portion 207 to the server 162 through the network 164 (at step S208). When the controlling portion 301 of the server 162 receives the error message through the communicating portion 302, the controlling portion 301 stops the mutual authenticating operation process (at step S230).

When the determined result at step S207 represents that the IC card public key PKic is valid, the decrypting portion 202 decrypts a signature S2 in the IC card public key certificate (PKic, S2) received at step S206 using a management center public key PKcnt stored in the management center public key storing portion 209 to generate PKcnt (S2) The compressing portion 204 compresses PKic using the hash function to generate H (PKic). Thereafter, the authenticating portion 206 collates PKcnt (S2) with H (PKic) (at step S2081).

When the determined result at step S209 represents that PKcnt (S2) does not match H (PKic), the controlling portion 201 of the management center 160 determines that the public key certificate (Pkic, S2) is a certificate that has not issued by the management center 160 and transmits an error message to the server 162 through the communicating portion 207 and the communicating portion 207 (at step S210). When the controlling portion 301 of the server 162 receives the error message through the communicating portion 302 (at step S210), the controlling portion 301 stops the mutual authenticating operation (at step S230).

When the determined result at step S209 represents that PKcnt (S2) matches H (PKic), the controlling portion 201 of the management center 160 determines that the IC card public key certificate (PKic, S2) received at step S206 is a public key certificate that has been issued by the management center 160. The random number generating portion 205 generates a random number Rcnt (at step S211). The encrypting portion 203 encrypts the random number Rcnt using an IC card public key PKic to generate PKic (Rcnt) (at step S212). The controlling portion 201 transmits PKic (Rcnt) as reply data of the mutual authenticating operation request to the server 162 through the communicating portion 207 and the network 164 (at step S213). When the controlling portion 301 of the server 162 receives the encrypted data PKic (Rcnt) through the communicating portion 302, the controlling portion 301 transmits PKic (Rcnt) to the IC card 167 through the IC card inputting-outputting portion 303 (at step S214).

When the controlling portion 401 of the IC card 167 receives PKic (Rcnt) from the inputting-outputting portion 402, the decrypting portion 403 decrypts PKic (Rcnt) using an IC card secret key SKic stored in the IC card secret key storing portion 408 to generate DRcnt (at step S215). Thereafter, the controlling portion 401 of the IC card 167 causes the random number generating portion 406 to generate a random number Ric (at step S216). The encrypting portion 404 encrypts the random number Ric using a management center public key PKcnt stored in the management center public key storing portion 409 to generate PKcnt (Ric) (at step S217) and transmits PKic (Ric) and DRcent as reply data to the mutual authenticating operation request to the server 162 through the inputting-outputting portion 402 (at step S218).

When the controlling portion 301 of the server 162 receives PKcnt (Ric) and DRcnt from the IC card inputting-outputting portion 303, the controlling portion 301 transmits PKcnt (Ric) and DRcnt as reply data of the mutual authenticating operation request to the management center 160 through the communicating portion 302 and the network 164 (at step S219). When the controlling portion 201 of the management center 160 receives PKcnt (Ric) and DRcnt from the communicating portion 207 (at step S220), the authenticating portion 206 collates the decrypted data DRcnt with the random number data Rcnt (at step S221). When the determined result at step S221 represents that DRcnt does not match Rcnt, the controlling portion 201 of the management center 160 determines that the IC card is an invalid IC card that does not have an IC card secret key paired with the IC card public key PKic and transmits an error message to the server 162 through the communicating portion 207 and the network 164 (at step S222). When the controlling portion 301 receives the error message from the communicating portion 302, the controlling portion 301 stops the mutual authenticating operation (at step S230).

When the determined result at step S221 represents that DRcnt matches Rcnt, the controlling portion 201 of the management center 160 determines that the IC card is a valid IC card that has an IC card secret key paired with the IC card public key PKic. The decrypting portion 202 decrypts PKcnt (Ric) using a management center secret key SKcnt stored in the management center secret key storing portion 208 to generate DRic and transmits DRic to the server 162 through the communicating portion 207 and the network 164 (at step S223). When the controlling portion 301 of the server 162 receives DRic from the communicating portion 302, the controlling portion 301 transmits DRic to the IC card 167 through the IC card inputting-outputting portion 303 (at step S224). When the controlling portion 401 of the IC card 167 receives DRic from the server 162 through the inputting-outputting portion 402 (at step S225), the authenticating portion 407 collates the random number Ric with DRic (at step S226).

When the determined result at step S226 represents that the random number Ric does not match DRic, the controlling portion 401 of the IC card 167 determines that the management center is an invalid management center that does not have the management center secret key SKcent and transmits an error message to the server 162 through the inputting-outputting portion 402 (at step S227). When the controlling portion 301 of the server 162 receives the error message from the IC card inputting-outputting portion 303, the controlling portion 301 stops the mutual authenticating operation. When the determined result at step S226 represents that Ric matches the decrypted data DRic, the controlling portion 401 of the IC card 167 determines that the management center is a valid management center that has the secret key SKcnt and transmits a normal completion message to the server 162 through the inputting-outputting portion 402 (at step S228). When the controlling portion 301 of the server 162 receives the normal completion message from the IC card inputting-outputting portion 303, the controlling portion 301 normally completes the mutual authenticating operation (at step S229).

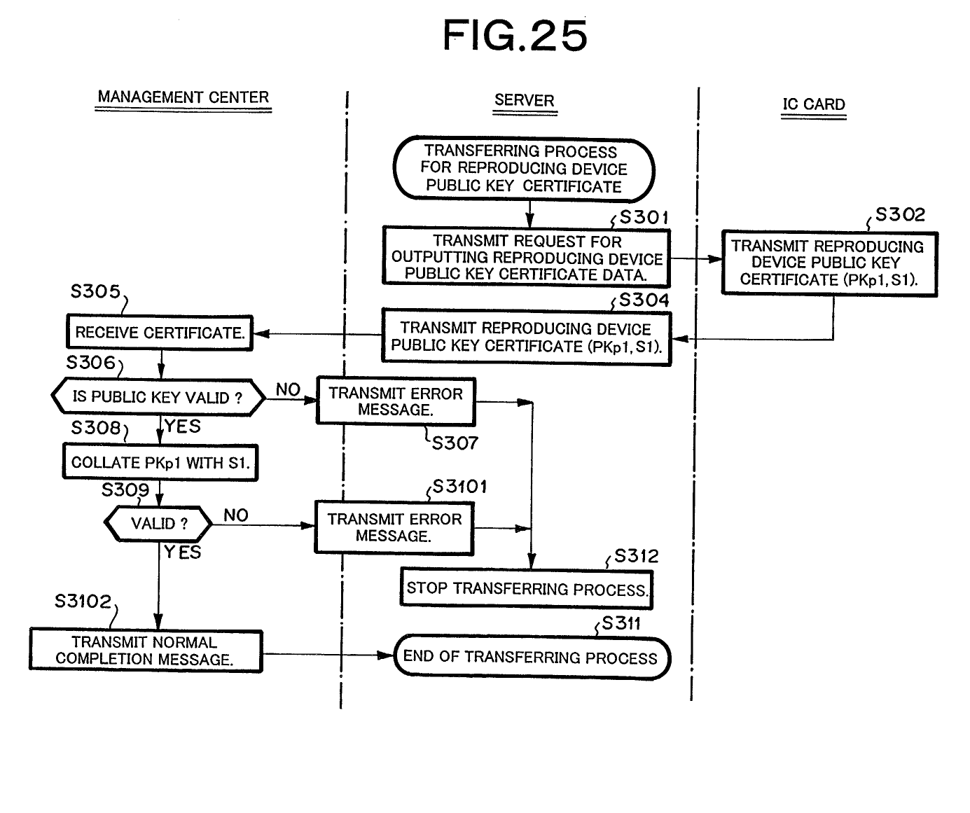

FIG. 25 shows a process of transferring a reproducing device public key certificate from the IC card 167 to the management center 160 after they have been mutually authenticated.

First of all, the controlling portion 301 of the server 162 transmits a request for reading the reproducing device public key certificate to the IC card 167 through the IC card inputting-outputting portion 303 (at step S301). When the controlling portion 401 of the IC card 167 receives the request for reading the reproducing device public key certificate from the server 162 through the inputting-outputting portion 402, the controlling portion 401 transmits a reproducing device public key certificate (PKp1, S1) stored in the reproducing device public key certificate storing portion 411 to the server 162 through the inputting outputting portion 402 (at step S302). When the controlling portion 301 of the server 162 receives the reproducing device public key certificate (PKp1, S1) from the IC card inputting-outputting portion 303, the controlling portion 301 transmits the reproducing device public key certificate (PKp1, S1) to the management center 160 through the communicating portion 302 and the network 164 (at step S304). When the controlling portion 201 of the management center 160 receives the reproducing device public key certificate (PKp1, S1) from the server 162 through the communicating portion 207 (at step S305), the controlling portion 201 searches the public key database 211 for the same public key as the public key PKp1 in the reproducing device public key certificate (PKp1, S1) and determines whether or not the public key is valid (at step S306).

When the determined result at step S306 represents that the reproducing device public key certificate received at step S305 is valid or expired, the controlling portion 201 of the management center 160 transmits an error message to the server 162 through the communicating portion 207 and the network (at step S207). When the controlling portion 301 of the server 162 receives the error message from the communicating portion 302, the controlling portion 301 stops the transferring process of the reproducing device public key certificate (at step S312). When the determined result at step S306 represents that the reproducing device public key certificate received at step S305 is valid, the decrypting portion 202 decrypts a signature S1 of the reproducing device public key certificate (PKp1, S1) using a management center public key PKcnt stored in the management center public key storing portion 209 to generate PKcnt (S1). The compressing portion 204 compresses PKp1 of the reproducing device public key certificate (PKp1, S1) using the hash function to generate H (PKp1). The authenticating portion 206 collates PKcnt (S1) with H (Pkp1) (at step S308).

When the determined result at step S309 represents that PKcnt (S1) does not match H (PKp1), the controlling portion 201 of the management center 160 determines that the reproducing device is an invalid reproducing device that does not have a reproducing device secret key SKp1 paired with the reproducing device public key PKp1 and transmits an error message to the server 162 through the communicating portion 207 and the network 164 (at step S3101). When the controlling portion 301 of the server 162 receives the error message from the communicating portion 302, the controlling portion 301 stops the transferring process for the reproducing device public key certificate (at step S312) When the determined result at step S309 represents that PKcnt (S1) matches H (PKp1), the controlling portion 201 of the management center 160 determines that the reproducing device is a valid reproducing device that has the reproducing device secret key SKp1 paired with the reproducing device public key PKp1 and transmits a normal completion message to the server 162 through the decrypting portion 202 and the network 164 (at step S3102). When the controlling portion 301 of the server 162 receives the normal completion message form the communicating portion 302, the controlling portion 301 normally completes the transferring process for the reproducing device public key certificate (at step S311).

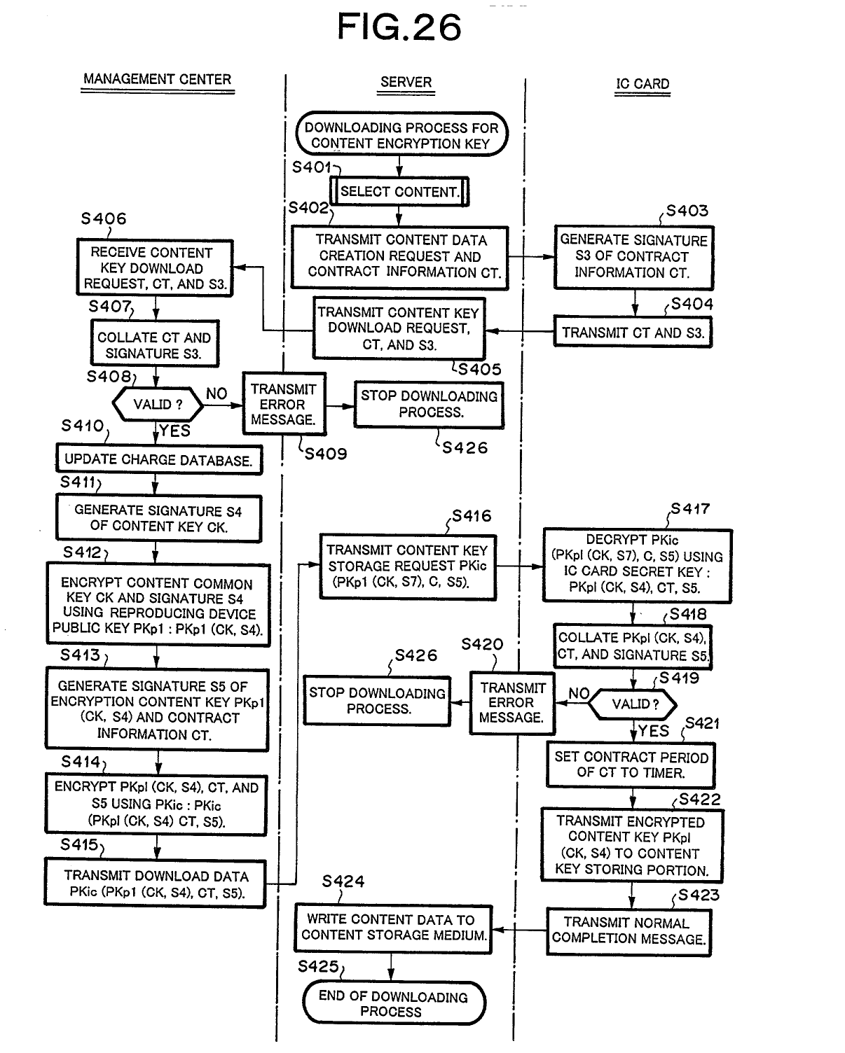

FIG. 26 is a flow chart showing a downloading process of information necessary for reproducing a content. The downloading process is preceded by the transferring process for the reproducing device public key certificate.

First of all, the user selects a content that he or she wants to rent on the displaying portion 306 and inputs a title name C and a rental period T of the content using the inputting portion 305 (at step S401). The controlling portion 301 of the server 162 transmits contract information CT that contains the title name C and the rental period T of the content and a contract data creation request to the IC card 167 through the IC card inputting-outputting portion 303 (at step S402). When the controlling portion 401 of the IC card 167 receives the contact data creation request and the contract information CT from the inputting-outputting portion 402, the compressing portion 405 compresses the contract information CT using the hash function to generate H (CT). The encrypting portion 404 encrypts H (CT) using an IC card secret key SKic stored in the IC card secret key storing portion 408 and generates a signature S3 (at step S403).

Thereafter, the controlling portion 401 of the IC card 167 transmits the contract information CT and the signature S3 to the server 162 through the inputting-outputting portion 402 (at step S404). When the controlling portion 301 of the server 162 receives the contract information CT and the signature S3 from the IC card inputting-outputting portion 303, the controlling portion 301 transmits the contract information CT, the signature S3, and a content key download request to the management center 160 through the communicating portion 302 and the network 164 (at step S405). When the controlling portion 201 of the management center 160 receives the content encryption key download request, the contract information CT, and the signature S3 from the communicating portion 207 (at step S406), the decrypting portion 202 decrypts S3 using the IC card public key PKic that has been determined as a valid public key by the above-described mutual authenticating operation to generate PKic (S3). The compressing portion 204 compresses the contract information CT using the hash function to generate H (CT). The authenticating portion 206 collates PKic (S3) with H (CT) (at step S407).

When the determined result at step S408 represents that PKic (S3) does not match H (CT), the controlling portion 201 of the management center 160 determines that the IC card 167 is invalid or data thereof has been falsified and transmits an error message to the server 162 through the communicating portion 207 and the network 164 (at step S409). When the controlling portion 301 of the server 162 receives the error message from the communicating portion 302, the controlling portion 301 stops the downloading process for the content encryption key (at step S426). When the determined result at step S408 represents that PKic (S3) matches H (CT), the controlling portion 201 of the management center 160 determines that the issuer of the contract information CT is the IC card 167 and that the data thereof has not been falsified and writes the contract information CT to the charge information database 212 (at step S410).

Thereafter, the controlling portion 201 of the management center 160 reads a content encryption key CK for the title name of the content corresponding to the contract information CT stored in the content key storing portion 210. The compressing portion 204 compresses CK using the hash function to generate H (CK). The encrypting portion 203 encrypts H (CK) using a management center secret key SKcnt stored in the management center secret key storing portion 208 to generate a signature S4 (at step S411). Thereafter, the encrypting portion 203 encrypts the content encryption key CK and the signature S4 using a reproducing device public key PKp1 to generate PKp1 (CK, S4) (at step S412). Thereafter, the compressing portion 204 compresses PKp1 (CK, S4) and the contract information CT using the hash function to generate H (PKp1 (CK, S4), CT). The encrypting portion 203 encrypts H (PKp1 (CK, S4), CT) using the management center secret key SKcnt to generate a signature S5 (at step S413).

Next, the encrypting portion 203 encrypts the encrypted content encryption key PKp1 (CK, S4), the contract information CT, and the signature S5 using an IC card public key PKic to generate PKic (PKp1 (CK, S4), CT, S5) (at step S414) and transmits PKic (PKp1 (CK, S4), CT, S5) as content key data against the content key download request to the server 162 through the communicating portion 207 and the network 164 (at step S415).

When the controlling portion 301 of the server 162 receives the content key data PKic (PKp1 (CK, S4), CT, S5) from the communicating portion 302, the controlling portion 301 transmits the content key data PKic (PKp1 (CK, S4), CT, S5) and a content key storage request to the IC card 167 through the IC card inputting-outputting portion 303 (at step S416). When the controlling portion 401 of the IC card 167 receives the content key storage request and the content key data PKic (PKp1 (CK, S4), CT, S5) from the inputting-outputting portion 402, the decrypting portion 403 decrypts PKic (PKp1 (CK, S4), CT, S5) using an IC card secret key SKic stored in the IC card secret key storing portion 408 to generate PKp1 (CK, S4), CT, and S5 (at step S417). Thereafter, the decrypting portion 403 decrypts the signature S5 using a management center public key PKcnt stored in the management center public key storing portion 409 and generates PKcnt (S5). The compressing portion 405 compresses PKp1 (CK, S4) and CT using the hash function to generate H (PKp1 (CK, S4), CT). The authenticating portion 407 collates PKcnt (S5) with H (PKp1 (CK, S4), CT) (at step S418).

When the determined result at step S419 represents that PKcnt (S5) does not match H (PKp1 (CK, S4), CT)), the controlling portion 401 of the IC card 167 determines that the data is invalid or has been falsified and transmits an error message to the server 162 through the inputting-outputting portion 402 (at step S420). When the controlling portion 301 of the server 162 receives the error message from the IC card inputting-outputting portion 303, the controlling portion 301 stops the downloading process for the content encryption key (at step S426). When the determined result at step S419 represents that PKcnt (S5) matches H (PKp1 (CK, S4), CT), the controlling portion 401 of the IC card 167 determines that the issuer of the data is the management center 160 and that the data has not been falsified, sets the contract period T of the contract information CT to the timer 413 (at step S421), and stores the encrypted content key PKp1 (CK, S4) to the content encryption key storing portion 412 (at step S422).

Thereafter, the controlling portion 401 of the IC card 167 transmits a normal completion message against the content key storage request to the server 162 through the inputting-outputting portion 402 (at step S423). When the controlling portion 301 of the server 162 receives the normal completion message from the IC card inputting-outputting portion 303, the controlling portion 301 writes content data stored in the content storing portion 307 to the content record medium 166 (at step S424). After the content data has been written to the content record medium 166, the user takes the IC card 167 and the content record medium 166 to home (at step S425).

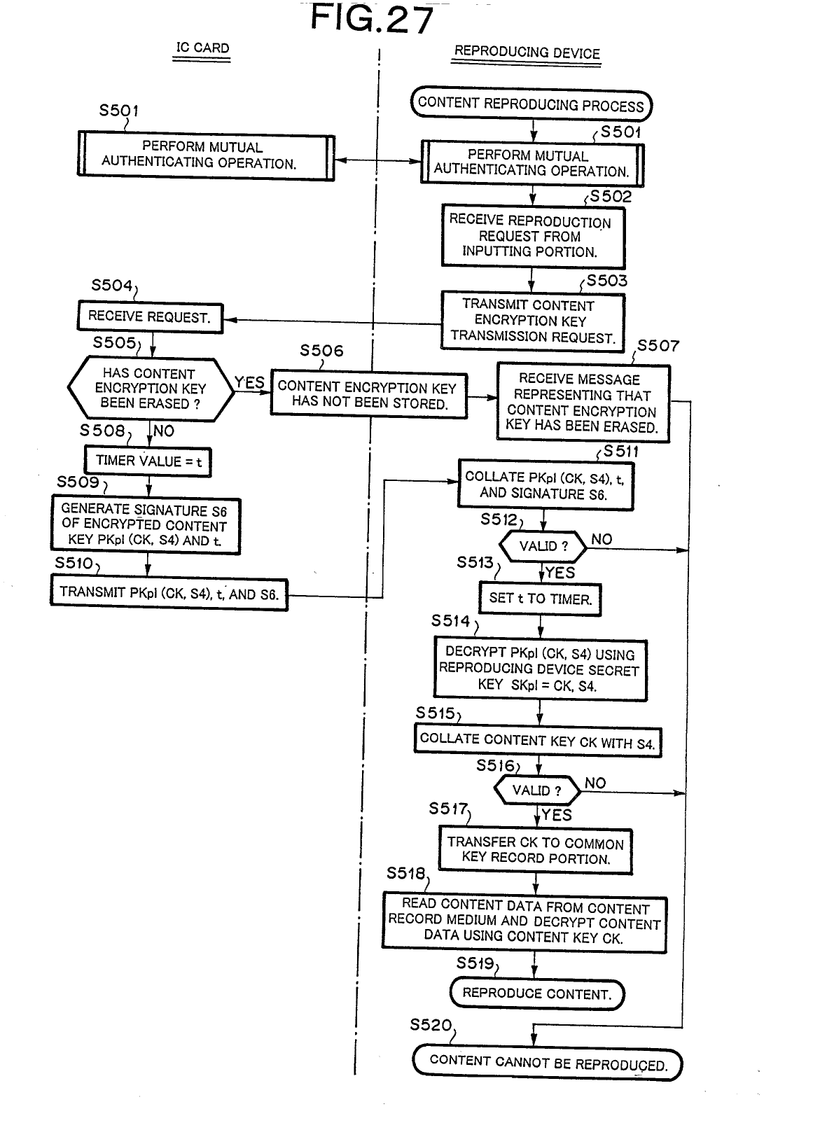

FIG. 27 is a flow chart showing a content reproducing process of the reproducing device 170 shown in FIG. 18. First of all, the user connects the content record medium 166 and the IC card 167 to the reproducing device 170. The reproducing device 170 and the IC card 167 perform the mutual authenticating operation corresponding to the above-described process (at step S501). The controlling portion 501 of the reproducing device 170 transmits a content encryption key transmission request to the IC card 167 through the IC card inputting-outputting portion 502 corresponding to a content reproduction command that is input from the operation inputting portion 508 (at step S503). When the controlling portion 401 of the IC card 167 receives the content encryption key transmission request from the inputting-outputting portion 402 (at step S504), the controlling portion 401 determines whether or not the content encryption key storing portion 412 stores data (at step S505).

When the determined result at step S505 represents that data has been erased from the content encryption key storing portion 412, the controlling portion 401 of the IC card 167 transmits a message representing that the content encryption key has been erased to the reproducing device 170 through the inputting-outputting portion 402 (at step S506). When the controlling portion 501 of the reproducing device 170 receives the message, the controlling portion 501 determines that the content reproducing operation cannot be performed and completes the content reproducing operation (at step S520). When the determined result at step S505 represents that data has been stored in the content encryption key storing portion 412, the controlling portion 401 of the IC card 167 reads the encrypted content encryption key PKp1 (CK, S4) and reads a timer value t from the timer 413 (at step S508). The compressing portion 405 compresses the encrypted content encryption key PKp1 (CK, S4) and the timer value t using the hash function to generate H (PKp1 (CK, S4), t). The encrypting portion 404 encrypts H (PKp1 (CK, S4), t) using an IC card secret key SKic stored in the IC card secret key storing portion 408 and generates a signature S6 (at step S509).

Thereafter, the controlling portion 401 of the IC card 167 transmits the encrypted content encryption key PKp1 (CK, S4), the timer value t, and the signature S6 to the reproducing device 170 through the inputting-outputting portion 402 (at step S510). When the controlling portion 501 of the reproducing device 170 receives the encrypted content encryption key PKp1 (CK, S4), the timer value t, and the signature S6 from the IC card inputting-outputting portion 303, the decrypting portion 503 decrypts the signature S6 using an IC card public key PKic to generate PKic (S6). The compressing portion 505 compresses the content encryption key PKp1 (CK, S4) and the timer value t using the hash function to generate H (PKp1 (CK, S4), t). The authenticating portion 507 collates PKic (S6) with H (PKp1 (CK, S4), t) (at step S511). When the determined result at step S512 represents that PKic (S6) does not match H (PKp1 (CK, S4), t), the controlling portion 501 of the reproducing device 170 determines that the data is invalid data or has been falsified and that the reproducing operation cannot be performed and completes the reproducing process (at step S520).

When the determined result at step S512 represents that PKic (S6) matches H (PKp1 (CK, S4), t), the controlling portion 501 of the reproducing device 170 sets the timer value t to the timer 513 (at step S513). Thereafter, the controlling portion 501 of the reproducing device 170 causes the decrypting portion 503 to decrypt the encrypted content encryption key PKp1 (CK, S4) using a reproducing device secret key SKp1 stored in the reproducing device secret key storing portion 510 to generate the content encryption key CK and the signature S4 (at step S514). Thereafter, the decrypting portion 503 decrypts the signature S4 using a management center public key PKcnt stored in the management center public key storing portion 511 to generate PKcnt (S4). The compressing portion 505 compresses the content encryption key CK using the hash function to generate H (CK). The authenticating portion 507 collates PKcnt (S4) with H (CK) (at step S515). When the determined result at step S516 represents that PKcnt (S4) does not match H (CK), the controlling portion 501 of the reproducing device 170 determines that the data is invalid data or has been falsified and that the data cannot be reproduced and completes the reproducing process (at step S520).

When the determined result at step S516 represents that PKcnt (S4) matches H (CK), the controlling portion 501 of the reproducing device 170 stores the content encryption key CK to the content encryption key storing portion 514 (at step S517). Thereafter, the controlling portion 501 of the reproducing device 170 reads content data from the content record medium 166 through the content record medium inputting-outputting portion 509. The content key decrypting portion 515 decrypts the content data using a content encryption key CK stored in the content encryption key storing portion 514 (at step S518) and reproduces the content (at step S519).

Next, the advantage of the structure shown in FIG. 18 will be described.

(1) Since a public key certificate of a reproducing device is stored to an IC card, the reproducing device can be securely restricted.

(2) Before a content is rented, a public key certificate of a reproducing device is stored to an IC card. Thus, the reproducing device can be securely and flexibly changed. As a result, the content can be securely reproduced by the changed reproducing device.

(3) Only a content encryption key, reproduction variation time information, and a public key certificate that have been issued by a management center are valid. Thus, the data is uniformly assured. Thus, contents can be securely circulated.

(4) Since an IC card stores reproduction validation time information and has a function for decreasing the reproduction variation period on real time, the reproduction variation period can be prevented from being falsified.

(5) An IC card and a reproducing device have a function for erasing a content encryption key necessary for reproducing a content. When the reproduction validation period expired, the erasing function works. Thus, the tampering resistance improves.

<Fourth Embodiment>

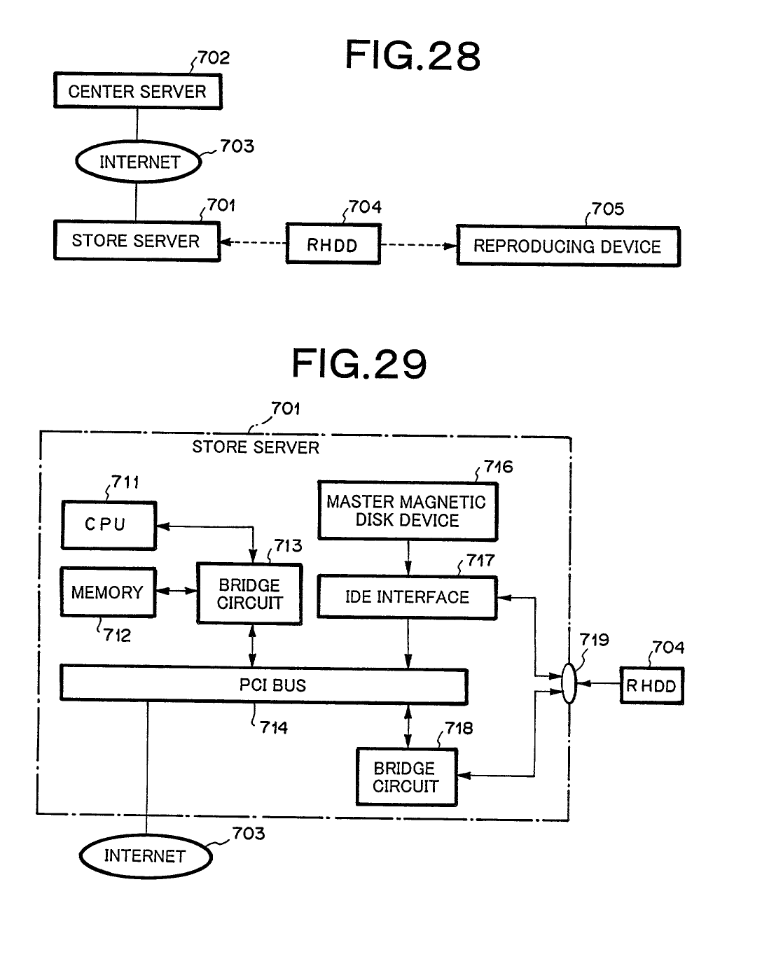

Next, with reference to FIG. 28 to FIG. 31, a fourth embodiment of the present invention will be described. According to the fourth embodiment, an RHDD contains a reading/writing circuit and a controlling circuit as well as a record medium.

FIG. 28 is a block diagram showing the structure of a content rental system according to the fourth embodiment of the present invention. In FIG. 28, reference numeral 701 is a store server disposed in a rental store. Reference numeral 702 is a center server that integrally manages a plurality of store servers 701. The center server 702 is connected to the store servers 701 through the Internet 703. The center server 702 is disposed in a management center that integrally manages the rental stores. The management center corresponds to the video software duplicator shown in FIG. 3. Reference numeral 704 is an RHDD that each user has. A user takes the RHDD to a rental store. At the rental store, the RHDD is connected to the store server 701. A content is downloaded from the store server 701 to the RHDD. The user returns to the house with the RHDD. The user sets the RHDD 704 to a reproducing device 705. The reproducing device 705 reproduces the content.

FIG. 29 is a block diagram showing the structure of the store server 701. In FIG. 29, reference numeral 711 is a CPU (Central Processing Unit). Reference numeral 712 is a memory. Reference numeral 713 is a bridge circuit that mutually connects the CPU 711, the memory 712, and a PCI (Peripheral Component Interconnect) bus 714. Reference numeral 716 is a master magnetic disk device that stores contents and disk commands supplied from the center server 702 (see FIG. 28) through the Internet 703. Reference numeral 717 is an IDE (Integrated Drive Electronics) interface that connects the master magnetic disk device 716 to the PCI bus 714. Reference numeral 718 is a bridge circuit that connects the PCI bus 714 and a terminal 719 that is connected to the RHDD 704.

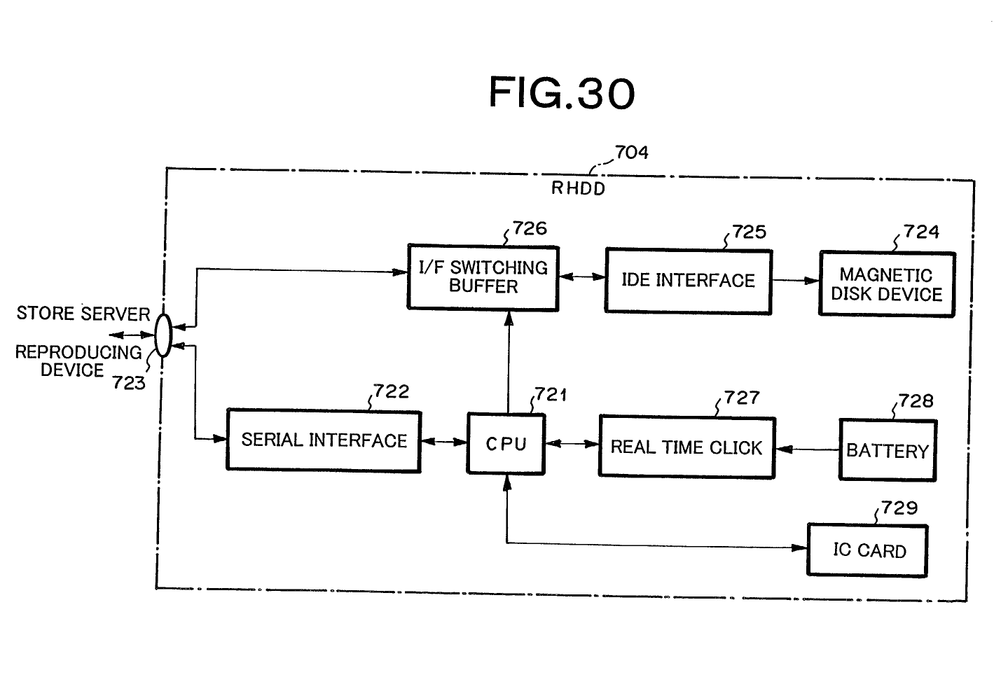

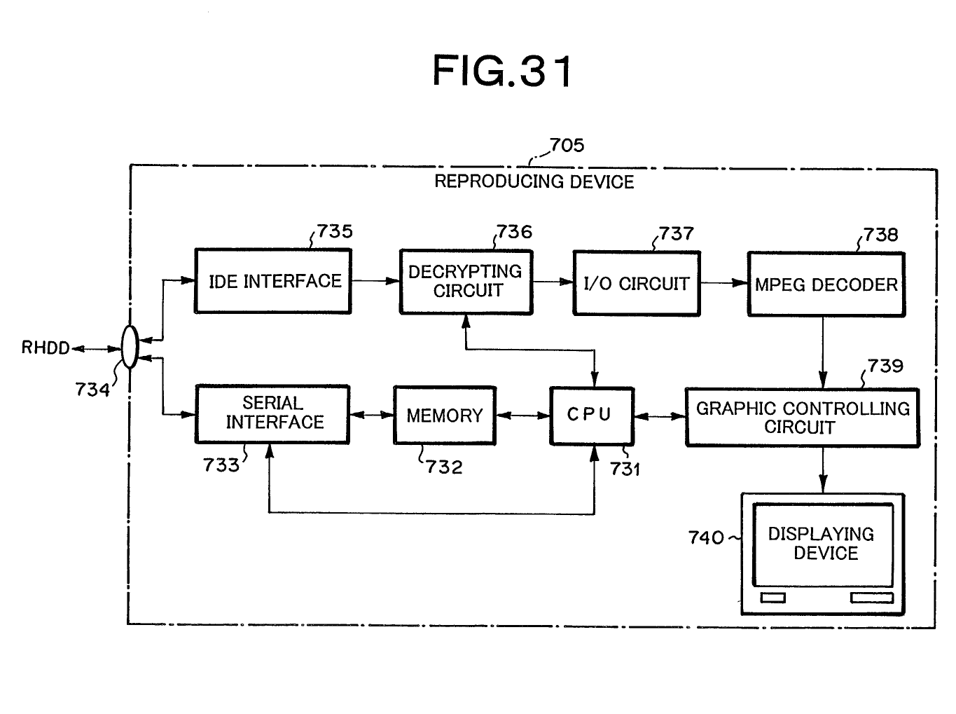

FIG. 30 is a block diagram showing the structure of the RHDD 704. In FIG. 30, reference numeral 721 is a CPU. Reference numeral 722 is a serial interface. Reference numeral 723 is a terminal that is connected to the terminal 719 of the store server 701 or a terminal 734 (see FIG. 31) of the reproducing device 705. Reference numeral 724 is a magnetic disk device that stores contents and disk commands that are read from the store server 701. Reference numeral 725 is an IDE interface. Reference numeral 726 is an I/F (Interface) switching buffer. Reference numeral 727 is a real time clock that is backed up by a battery 728. Reference numeral 729 is an IC card.

FIG. 31 is a block diagram showing the structure of the reproducing device 705. In FIG. 31, reference numeral 31 is a CPU. Reference numeral 732 is a non-volatile memory. Reference numeral 733 is a serial interface. Reference numeral 734 is a terminal that is connected to the terminal 723 of the RHDD 704. Reference numeral 735 is an IDE interface. Reference numeral 736 is a decrypting circuit that decrypts an encrypted content and disk command supplied from the RHDD 704 connected to the terminal 734 through the terminal 734. Reference numeral 705 is an I/O circuit that connects the decrypting circuit 736 and an MPEG decoder 738. The MPEG decoder 738 decompresses compressed data to original data corresponding to the MPEG standard. A graphic controlling circuit 739 displays a picture on a displaying device 740 corresponding to data that is output from the MPEG decoder 738.

Next, the operation of the fourth embodiment will be described.

The center server 702 (see FIG. 28) delivers a content and a disk command to a store server 701 through the Internet 703. In addition, the center server 702 delivers data that represents the permitted number of times of the downloading operation for the content to the store server 701. The delivered content is pre-encrypted and pre-compressed corresponding to the MPEG standard by the center server 702. The delivered content, disk command, and data representing the permitted number of times of the downloading operation are stored to the master magnetic disk device 716 through the PCI bus 714 and the IDE interface 717 of the store server 701 (see FIG. 29).

On the other hand, the user buys a set of an RHDD 704 and a reproducing device 705. When the user buys them, attribute information (name, authorized number, charge information, address, telephone, and so forth) of the user (buyer) is stored to the IC card of the RHDD 704. When the RHDD does not have the IC card, the attribute information is stored to the magnetic disk device 724. In addition, the IC card stores the identification number of the reproducing device 705. The memory 732 of the reproducing device 705 also stores the same identification number of the reproducing device 705. The user takes the RHDD 704 to the rental store. The user sets the RHDD 704 to the store server 701 corresponding to an instruction of a store clerk.

When the RHDD 704 is set to the store server 701, the CPU 721 of the RHDD 704 reads the user attribute information from the IC card 729 and outputs the user attribute information to the store server 701. The attribute information is stored to the memory 712 through the bridge circuit 718, the PCI bus 714, and the bridge circuit 713. The CPU 711 transmits the attribute information to the center server 702 through the Internet 703. The center server 702 determines both (1) the availability that contents can be rented to the user and (2) the rental fee on the basis of the received attribute information, and transmits the results to the store server 701.

Thereafter, when the results received from the center server 702 represent that contents can be rented to the user, the CPU 711 of the store server 701 causes a display screen (not shown) to display a list of contents stored in the master magnetic disk device 716. When the user selects a content that he or she wants to download from the list, the selected content is read from the master magnetic disk device 716 and written to the magnetic disk device 724 of the RHDD 704. Thereafter, the CPU 711 reads a decryption key from the memory 712 and outputs the decryption key to the RHDD 704. In addition, the CPU 711 calculates the reproduction validation time and outputs the calculated result to the RHDD 704. The decryption key is written to the IC card 729. The data representing the reproduction validation time is written to the magnetic disk device 724.

Thereafter, the CPU 711 increases the download times count area of the memory 712 by “1”. The value of the count area represents the number of times of the downloading operation for the content. Thereafter, the CPU 711 compares the value of the count area with the data representing the permitted number of times of the downloading operation stored in the master magnetic disk device 716. When the value of the count area matches the permitted number of times of the downloading operation, the CPU 711 prohibits the downloading operation and transmits a message representing the prohibition of the downloading operation to the center server 702.

When the content has been downloaded from the store server 701 to the RHDD 704, the user returns home with the RHDD 704. The user sets the RHDD 704 to the reproducing device 705 and presses the reproduction start button (not shown). When the user presses the reproduction start button, the CPU 721 of the RHDD 704 reads the identification number of the IC card 729 and outputs the identification number to the reproducing device 705. The identification number is supplied to the CPU 731 through the serial interface 733. The CPU 731 compares the supplied identification number with the identification number stored in the memory 732. When those identification numbers match, the CPU 731 moves on to the content reproducing process. When they do not match, the CPU 731 issues an alarm and does not perform the content reproducing process.

After the CPU 721 of the RHDD 704 outputs the identification number, the CPU 721 reads data that represents the reproduction validation time from the magnetic disk device 724 and compares the reproduction validation time with the current time that is output from the real time clock 727. When the current time exceeds the reproduction validation time, the CPU 721 issues an alarm and stops the process. When the current time does not exceed the reproduction validation time, the CPU 721 reads a decryption key from the IC card 729 and outputs the decryption key to the reproducing device 705. The decryption key is supplied to the decrypting circuit 736 through the IDE interface 735.

Thereafter, the content is successively read from the magnetic disk device 724 of the RHDD 704 and output to the reproducing device 705. The decrypting circuit 736 of the reproducing device 705 decrypts the content using the decryption key and inputs the decrypted content to the MPEG decoder 738 through the I/O circuit 737. The MPEG decoder 738 decompresses the content. The displaying device 740 displays the decompressed content through the graphic controlling circuit 739.

According to the fourth embodiment, when a content stored in the RHDD is reproduced by a reproducing device having a different identification number, the different identification number may be stored to the magnetic disk device of the RHDD. When the user sets the RHDD to the store server, it detects the different identification number of the reproducing device and prohibits a content from being downloaded to the RHDD.

In addition, when the reproduction validation time expired, the CPU 721 of the RHDD 704 may erase the decryption key stored in the IC card 729. Alternatively, the reproducing device 705 may have a real time clock. In this case, the RHDD 704 outputs data that represents the reproduction validation time. The reproducing device 705 determines whether or not the current time exceeds the reproduction validation time.

When a content is downloaded to the RHDD 704 of the user, data that represents the permitted number of times of the reproducing operation is stored to the magnetic disk device 724. When the number of times of the reproducing operation exceeds the permitted number of times of the reproducing operation, the reproducing operation may be prohibited. The number of times of the reproducing operation can be determined in various manners. For example, a reproduction marker may be placed at a particular position in the range from the middle to the end of a content. Whenever the reproduction marker is detected, the reproducing operation is counted. The reproduction marker may be placed at any position of a content. For example, reproduction markers may be placed at the beginning and the end of a content. Only when both the reproduction markers are detected, the reproducing operation may be counted. Alternatively, the reproduction marker may be placed at the beginning of a content. Whenever the beginning of a content is detected, the reproducing operation may be counted.

According to the present invention (claim 1), the following effects can be obtained.

(1) The antinomy between improper stock and loss of business chance of video rental stores can be solved.

(2) Since part of rental fees collected from customers through the circulation system flows back to a video source production company, it can have higher sales than before.

(3) Rental video tapes at low prices can be prevented from flowing out to the sell video market.

According to the present invention (claim 2), new commercial information can be always placed in rental record mediums. Thus, customers can always view new commercials. In comparison with conventional commercials, high commercial effects can be expected. In addition, those commercials become new incomes. Thus, video software title companies and rental stores can be well managed. In addition, the customers can enjoy advantageous advertisements.

According to the present invention (claim 4 to claim 8), when a predetermined period elapsed, information necessary for reproducing a content is erased. Thus, the content cannot be reproduced. Thus, when the present invention is applied to a rental system, customers do not need to return content mediums to stores. When a timer is disposed, the period for which information necessary for reproducing a content is erased can be accurately set.

According to the present invention (claim 9 to claim 19), digital video information can be prevented from illegally copied and circulated. In addition, the video market can be prevented from getting confused.

Although the present invention has been shown and described with respect to the best mode embodiment thereof, it should be understood by those skilled in the art that the foregoing and various other changes, omissions, and additions in the form and detail thereof may be made therein without departing from the spirit and scope of the present invention.

What is claimed is:

1. A contents rental system, comprising:
a content producer for producing a content;
a rental business server, disposed in a store managed by a rental business operator, for recording the content produced by said content producer and downloading the contents to a record medium corresponding to a command issued by a customer; and
a reproducing device, disposed in a house of the customer, for reproducing the contents from the record medium.

2. The content rental system as set forth in claim 1,
wherein said rental business operator records an advertisement picture to the record medium along with the content.

3. The content rental system as set forth in claim 2,
wherein when an icon contained in the advertisement picture is clicked, said reproducing device is connected to an advertisement server through the Internet.

4. The content rental system as set forth in claim 1,
wherein the record medium comprises:
a content storing portion for storing the content encrypted;
a memory for storing a decryption key for decrypting the content encrypted; and
a capacitor for backing up said memory,
wherein said capacitor is charged by said rental business server.

5. The content rental system as set forth in claim 1,
wherein the record medium comprises:
a content storing portion for storing the content;
a memory for storing a control algorithm for reading the content; and
a capacitor for backing up said memory,
wherein said capacitor is charged by said rental business server.

6. The content rental system as set forth in claim 1,
wherein the record medium comprises:
a content storing portion for storing the content encrypted;
a memory for storing a decryption key for decrypting the content; and
a timer for causing the decryption key stored in said memory to be erased when a predetermined time period elapses after the record medium is connected to said rental business server.

7. The content rental system as set forth in claim 1,
wherein the record medium comprises:
a content storing portion for storing the content;
a memory for storing a control algorithm for reading the content; and
a timer for causing the control algorithm stored in said memory to be erased when a predetermined time period elapses after the record medium is connected to said rental business server.

8. The content rental system as set forth in claim 6 or 7, further comprising:
a capacitor, charged by said rental business server, for supplying a power to said timer.

9. A content rental system for downloading a content to a record medium of a customer and managing security of the content corresponding to data stored in an IC card of the customer, comprising:
a content producer for producing the content;
a management center for delivering the content produced by said content producer to a plurality of rental business operators;
a rental business server, disposed in a store managed by each of the rental business operators, for recording the content delivered from said management center, downloading the recorded content to the record medium corresponding to a command issued by the customer, and managing the security of the content corresponding to the data stored in the IC card; and
a reproducing device, disposed in a house of the customer, for restoring the content from the record medium and managing the security of the content corresponding to the data stored in the IC card.

10. The content rental system as set forth in claim 9,
wherein when the IC card is set to said reproducing device, said reproducing device authenticates the IC card and the IC card authenticates said reproducing device.

11. The content rental system as set forth in claim 10,
wherein said reproducing device is authenticated by a process in which said reproducing device transmits a reproducing device public key certificate to the IC card and the IC card authenticates the reproducing device public key certificate, and
wherein the IC card is authenticated by a process in which the IC card transmits an IC card public key certificate to said reproducing device and said reproducing device authenticates the IC card public key certificate.

12. The content rental system as set forth in claim 10,
wherein said reproducing device is authenticated in such a manner that the IC card encrypts a random number using a reproducing device public key and transmits the encrypted random number to said reproducing device, that said reproducing device decrypts the encrypted random number using a reproducing device secret key and transmits the decrypted random number to the IC card, and that the IC card authenticates said reproducing device using the decrypted random number.

13. The content rental system as set forth in claim 10,
wherein the IC card is authenticated in such a manner that said reproducing device encrypts a random number using an IC card public key and transmits the encrypted random number to the IC card, that the IC card decrypts the encrypted random number using an IC card secret key and transmits the decrypted random number to said reproducing device, and that said reproducing device authenticates the IC card using the decrypted random number.

14. The content rental system as set forth in claim 9,
wherein when the IC card is set to said rental business server, said rental business server authenticates the IC card in cooperation with said management center.

15. The content rental system as set forth in claim 14,
wherein the IC card is authenticated by a process in which the IC card transmits an IC card public key certificate to said management center through said rental business server and said management center authenticates the IC card public key certificate.

16. The content rental system as set forth in claim 14,
wherein the IC card is authenticated in such a manner that said management center encrypts a random number using an IC card public key and transmits the encrypted random number to the IC card through said rental business server, that the IC card decrypts the encrypted random number using an IC card secret key and transmits the decrypted random number to said management center through said rental business server, and that said management center authenticates the IC card using the decrypted random number.

17. The content rental system as set forth in claim 14,
wherein when the IC card is set to said rental business server, the IC card transmits a reproducing device public key certificate to said management center through said rental business server and said management center authenticates said reproducing device corresponding to the reproducing device public key certificate.

18. The content rental system as set forth in claim 9,
wherein when the record medium and the IC card are set to said rental business server and the customer selects a content, said rental business server transmits contract information to the IC card,
the IC card encrypts the contract information and transmits the encrypted contract information to said management center through said rental business server,
after said management center decrypts the encrypted contract information and authenticates the contract information, said management center encrypts an encryption key of the content selected by the customer and transmits the encrypted content to the IC card through said rental business server,
after the IC card decrypts the encrypted content encryption key and authenticates the content, the IC card transmits a normal completion message to said rental business server, and
said rental business server receives the normal completion message and downloads the content to the record medium.

19. The content rental system as set forth in claim 9,
wherein when the record medium and the IC card are set to said reproducing device, said reproducing device transmits a content encryption key transmission request to the IC card,
the IC card receives the transmission request, encrypts a content encryption key, and transmits the encrypted content encryption key to said reproducing device, and
after said reproducing device decrypts the encrypted content encryption key and authenticates the decrypted content encryption key, said reproducing device reproduces the content using the decrypted content encryption key.
